(19) United States
(12) Patent Application Publication
(10) Pub. No.: US 2024/0175308 A1
(43) Pub. Date: May 30, 2024

(54) DOOR CLOSER AND ASSIST SYSTEM AND METHOD OF USE

(71) Applicant: ASSA ABLOY Accessories and Door Controls Group, Inc., Monroe, NC (US)

(72) Inventors: Scott Speck, Waxhaw, NC (US); Brian D. Hass, Monroe, NC (US)

(73) Assignee: ASSA ABLOY Accessories and Door Controls Group, Inc., Monroe, NC (US)

(21) Appl. No.: 18/520,732

(22) Filed: Nov. 28, 2023

Related U.S. Application Data
(60) Provisional application No. 63/428,485, filed on Nov. 29, 2022.

(51) Int. Cl. E05F 15/63; E05F 1/10

(52) U.S. Cl. CPC E05F 15/63; E05F 1/105; E05F 2015/631; E05Y 2201/64; E05Y 2201/684; E05Y 2400/32; E05Y 2900/132

(57) ABSTRACT

A door closer and assist system that utilizes a door closer and door assist that aids in reducing the force required to open the door and/or increasing the force for closing the door. The door closer may be installed along with the door assist, or the door assist may be installed to any door closer that is already installed to a door. The door assist may include a track and a drive assembly having a motor assembly, a carriage, and a drive shaft. The motor assembly may have a drive train, a motor, and a controller. One or more sensors may be used to determine when to activate the motor to aid in opening and/or closing the door. The door closer and assist system allows for a door to be closed with a force that is greater than or equal to the force required to open the door.

### PRIORITY CLAIM UNDER 35 U.S.C. § 119

The present Application for a Patent claims priority to U.S. Provisional Patent Application Ser. No. 63/428,485 entitled “Door Closer and Assist System and Method of Use”, filed on Nov. 29, 2022 which is assigned to the assignee hereof and hereby expressly incorporated by reference herein.

### FIELD

The present invention relates to a door closer and assist system, and more particularly, to utilizing a door assist to apply torque to a door closer during opening and/or closing in order to aid in allowing the door to close with more force than is required to open the door.

### BACKGROUND

Door systems may include door operators, door closers, or other like systems that control the operation of opening and/or closing a door. A door operator is a device that is able to automatically open and close a door or other barrier without the need for any manual force provided by a user. Alternatively, door closers may be manually opened, and thereafter, use a spring or other device for automatically closing the door.

### SUMMARY

As will be described herein, the door closer and assist system is operatively coupled to a door assembly (e.g., door, door frame, and hinges). The door closer and assist system may comprise a door closer and a door assist. The door closer may be installed along with the door assist, or the door assist may be installed to any door closer already installed on a door assembly. The door assist may comprise a track and a drive assembly. Generally, the drive assembly comprises a motor and a drive shaft, which mechanically transfers the energy generated from the motor to the drive shaft and ultimately to the door closer. In some embodiments, the drive assembly may comprise a motor assembly, a carriage, and a drive shaft.

The motor assembly may comprise a drive train, a motor, and a controller. Furthermore, the door assist may be operatively coupled to one or more sensors (e.g., a position sensor, a force sensor, an accelerometer sensor, or the like) used to determine when to activate the motor to aid in opening and/or closing the door through the use of the drive arm operatively coupled to the door closer. The door closer and assist system allows for a door to be closed with a force that is greater than or equal to the force required to open the door. The door closer and assist system may be used to meet governmental, customer, or other like entity requirements for the force for opening or closing a door. In particular embodiments, the door closer and assist system may allow for meeting the requirements set by the Americans with Disabilities Act of 1990 (ADA), or any updates thereto over time. As such, in particular embodiments the door closer and assist system may meet the current (at the time of filing this application) requirements that the door may be manually opened (with or without the aid of the door assist) with a force that is less than or equal to five lbs of force, while during closing the door closer (with or without the aid of the door assist) is able to close the door with greater than or equal to five lbs of force.

One embodiment of the present disclosure is a door assist system for a door closer. The system comprises a track and a drive assembly operatively coupled to the track. The track is configured to be operatively coupled with a door or with a door frame or a wall. The drive assembly is configured to be operatively coupled with the door closer through a drive arm, and the door closer is configured to be operatively coupled to the opposite of the door or the door frame or the wall to which the track is operatively coupled. The drive assembly is configured to move the drive arm and slide with respect to the track to aid in opening or closing the door.

In further accord with embodiments, the drive assembly comprises a carriage, a motor assembly operatively coupled to the carriage, and a drive shaft operatively coupled to the motor assembly. The drive shaft is configured to be operatively couple to the drive arm. The energy generated by the motor assembly is mechanically transferred to the drive shaft.

In other embodiments, the carriage comprises one or more slides configured to contact track surfaces allowing the carriage to slide with respect to the track.

In still other embodiments, the carriage comprises one or more carriage projections configured to extend into one or more holder cavities formed by one or more track projections. The one or more carriage projections and the one or more holder cavities locate the carriage within the track.

In yet other embodiments, the one or more carriage projections comprise four carriage projections, and the one or more holder cavities comprise four holder cavities formed by four track projections.

In other embodiments, the carriage comprises a first carriage portion, and a second carriage portion operatively coupled to the first carriage portion to secure the motor assembly and the drive shaft at least partially within the carriage.

In further accord with embodiments, the motor assembly comprises a motor and a drive train operatively coupled to the motor. The motor assembly has a reduction ratio of at least 30 to 1 to transfer torque from the motor to the drive shaft.

In other embodiments, the track comprises an upper portion, a face portion, and a mounting portion.

In still other embodiments, the track further comprises a lower portion defining a drive shaft aperture. The drive shaft aperture allows a drive shaft of the drive assembly to slide within the drive shaft aperture when the drive assembly slides with respect to the track.

In yet other embodiments, the track further comprises one or more holder projections extending into a track cavity defined by the track. The one or more holder projections and the track define one or more holder cavities for securing at least a portion of the drive assembly within the track cavity.

In other embodiments, the system further comprises one or more sensors to determine when to activate or deactivate the drive assembly. The one or more sensors comprise a position sensor, a force sensor, or an accelerometer sensor.

In further accord with embodiments, the one or more sensors comprise the position sensor, which is configured to identify a position of the door or the drive assembly for activating or deactivating the drive assembly.

In other embodiments, the door assist system and the door closer are configured to allow opening of the door with less than or equal to five lbs of force and closing of the door with greater than or equal to five lbs of force.

In yet other embodiments, the drive assembly is activated to aid in closing the door when the door closer has a closing force that is less than or equal to five pounds of force.

In still other embodiments, the drive assembly is activated to aid in opening the door when the door closer has a closing force that is greater than or equal to five pounds of force.

Another embodiment of the present disclosure is a door closer and assist system. The system comprises a door assist comprising a track and a drive assembly operatively coupled to the track. The system further comprises a door closer and a drive arm operatively coupling the door assist and the door closer. The door closer is configured to be operatively coupled with a door or with a door frame or a wall. The track is configured to be operatively coupled to the opposite of the door or the door frame or the wall to which the door closer is operatively coupled. The drive assembly is configured to move the drive arm and slide with respect to the track to aid in opening or closing the door.

In further accord with embodiments, the drive assembly comprises a carriage, a motor assembly operatively coupled to the carriage, and a drive shaft operatively coupled to the motor assembly. The drive shaft is operatively coupled to the drive arm and energy generated by the motor assembly is mechanically transferred to the drive shaft.

In other embodiments, the motor assembly comprises a motor and a drive train operatively coupled to the motor and the drive shaft. The motor assembly has a reduction ratio of at least 30 to 1 to transfer torque from the motor to the drive shaft.

In still other embodiments, the door closer comprises a spring to close the door and a damper operatively coupled to the spring to control a closing speed of the door.

Another embodiment of the present disclosure is a method of assisting in opening or closing a door using a door closer and assist system. The system comprises a door assist having a track and a drive assembly operatively coupled to the track and a door closer having a drive arm operatively coupling the door assist and the door closer. The door closer is operatively coupled with a door or a with door frame or a wall, and the track is operatively coupled to the opposite of the door or the door frame or the wall to which the door closer system is operatively coupled. The drive assembly is configured to move the drive arm and slide with respect to the track to aid in opening or closing the door. The method comprises identifying when the door is being moved in an open direction and an opening force to open the door is greater than or equal to a set opening force. In response, activating the drive assembly to assist in opening the door. Alternatively, or additionally, the method comprises identifying when the door is being moved in a closed direction and a closing force to close the door is less than or equal to a set closing force. In response, activating the drive assembly to assist in closing the door.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

FIG. 1 is a perspective view of a door closer and assist system installed on a door assembly, in accordance with some embodiments of the present disclosure.

FIG. 2 is a front view of the door closer and assist system of FIG. 1, in accordance with some embodiments of the present disclosure.

FIG. 3 is a perspective enlarged view of a door closer and assist system installed on a door assembly, in accordance with some embodiments of the present disclosure.

FIG. 4 is an end perspective enlarged view of a door closer and assist system installed on a door assembly, in accordance with some embodiments of the present disclosure.

FIG. 5 is a perspective top view of a door closer and assist system installed on the door assembly illustrating the drive assembly within the track, in accordance with some embodiments of the present disclosure.

FIG. 6 is a perspective bottom view of a door closer and assist system installed on the door assembly illustrating the drive assembly within the track, in accordance with some embodiments of the present disclosure.

FIG. 7 is a top view of a door closer and assist system installed on the door assembly illustrating the drive assembly within the track, in accordance with some embodiments of the present disclosure.

FIG. 8 is a bottom perspective view of a door closer and assist system, in accordance with some embodiments of the present disclosure.

FIG. 9 is an end view of a door closer and assist system, in accordance with some embodiments of the present disclosure.

FIG. 10 is a perspective view of a door closer and assist system installed on the door assembly with the track removed, in accordance with some embodiments of the present disclosure.

FIG. 11 is a perspective view of a door closer and assist system with the track removed, in accordance with some embodiments of the present disclosure.

FIG. 12 is a top view of a door closer and assist system with the track removed, in accordance with some embodiments of the present disclosure.

FIG. 13 illustrates a perspective cross sectional view of the drive assembly and track of the assist system, in accordance with some embodiments of the present disclosure.

FIG. 14 illustrates a side cross sectional view of the drive assembly and track of the assist system, in accordance with some embodiments of the present disclosure.

FIG. 15 illustrates a perspective view of the drive assembly of the assist system, in accordance with some embodiments of the present disclosure.

FIG. 16 illustrates a perspective view of the drive assembly of the assist system illustrating the gear assembly of the drive assembly, in accordance with some embodiments of the present disclosure.

FIG. 17 illustrates a perspective cross sectional view of the drive assembly of the assist system, in accordance with some embodiments of the present disclosure.

FIG. 18 illustrates a side cross sectional view of the drive assembly of the assist system, in accordance with some embodiments of the present disclosure.

FIG. 19 illustrates an exploded view of the drive assembly of the assist system, in accordance with some embodiments of the present disclosure.

FIG. 20 illustrates an end view of the drive assembly within the track of the assist system, in accordance with some embodiments of the present disclosure.

FIG. 21 illustrates an enlarged perspective view of the slides of the drive assembly within the track of the assist system, in accordance with some embodiments of the present disclosure.

FIG. 22 illustrates a top perspective view of the track of the assist system, in accordance with some embodiments of the present disclosure.

FIG. 23 illustrates a bottom perspective view of the track of the assist system, in accordance with some embodiments of the present disclosure.

FIG. 24 illustrates an end view of the track of the assist system, in accordance with some embodiments of the present disclosure.

FIG. 25 illustrates a perspective view of the door closer system, in accordance with some embodiments of the present disclosure.

FIG. 26 illustrates a perspective cross sectional view of the door closer system, in accordance with some embodiments of the present disclosure.

FIG. 27 illustrates an exploded view of the door closer system, in accordance with some embodiments of the present disclosure.

FIG. 28A illustrates a block diagram of the motor assembly, in accordance with some embodiments of the present disclosure.

FIG. 28B illustrates a block diagram of the user computer system, in accordance with some embodiments of the present disclosure.

FIG. 29 illustrates a process for installing and/or operating the door closer and assist system, in accordance with some embodiments of the present disclosure

FIG. 30A is a perspective top view of a door closer and assist system in an open position, in accordance with some embodiments of the present disclosure.

FIG. 30B is a perspective top view of a door closer and assist system in operation beginning to close the door, in accordance with some embodiments of the present disclosure.

FIG. 30C is a perspective top view of a door closer and open assist system in operation that aids in closing the door, in accordance with some embodiments of the present disclosure.

FIG. 30D is a perspective top view of a door closer and assist system in operation continuing to aid in closing the door, in accordance with some embodiments of the present disclosure.

### DETAILED DESCRIPTION

The following detailed description teaches specific example embodiments of the invention. Other embodiments do not depart from the scope of the present invention. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including” when used herein, specify the presence of stated features, steps, operations, elements, and/or components, but do not preclude the presence or addition of one or more other features, steps, operations, elements, components, and/or groups thereof.

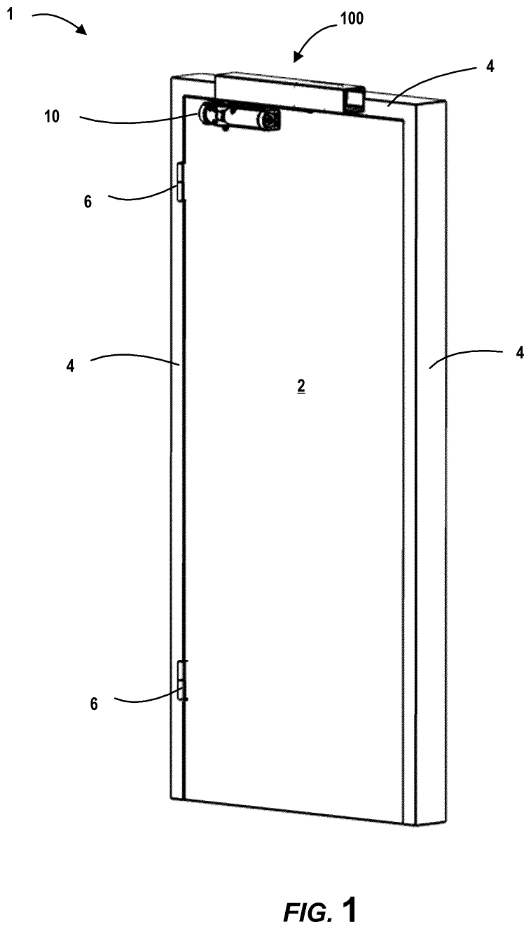

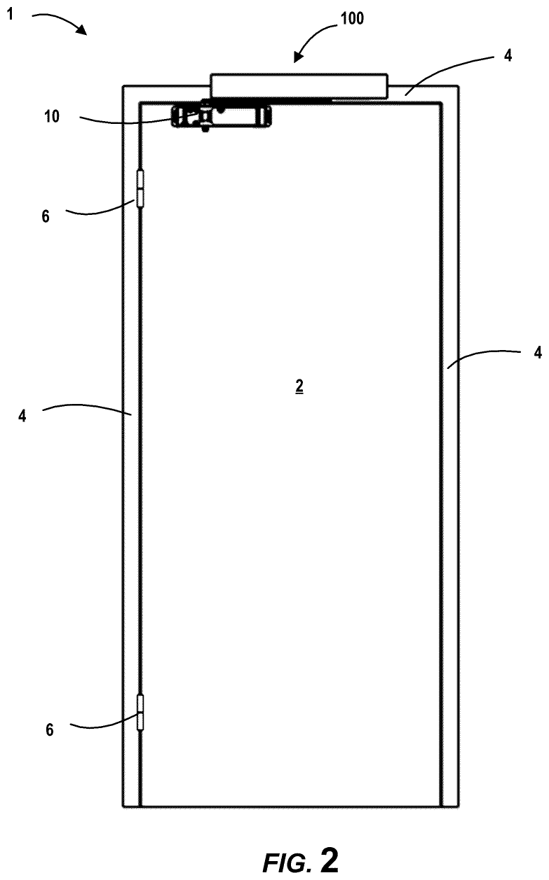

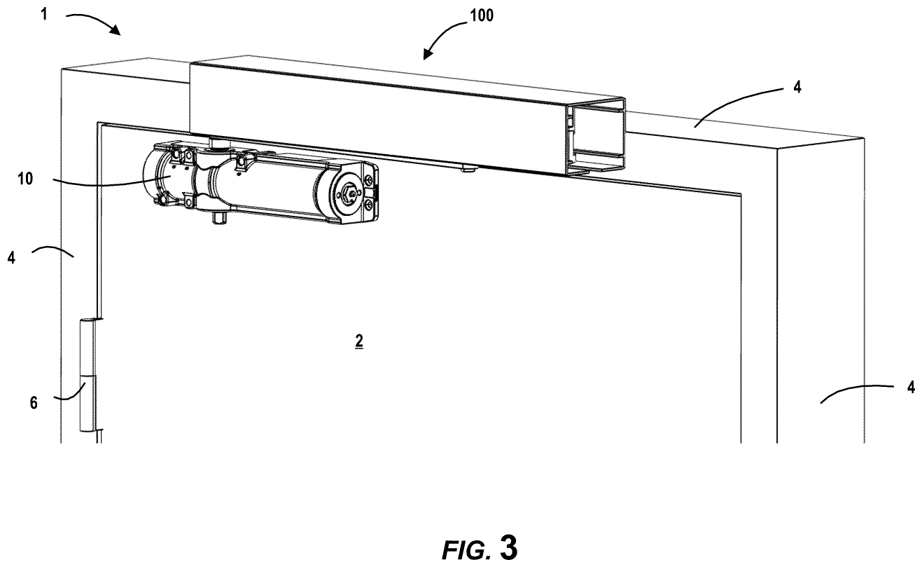

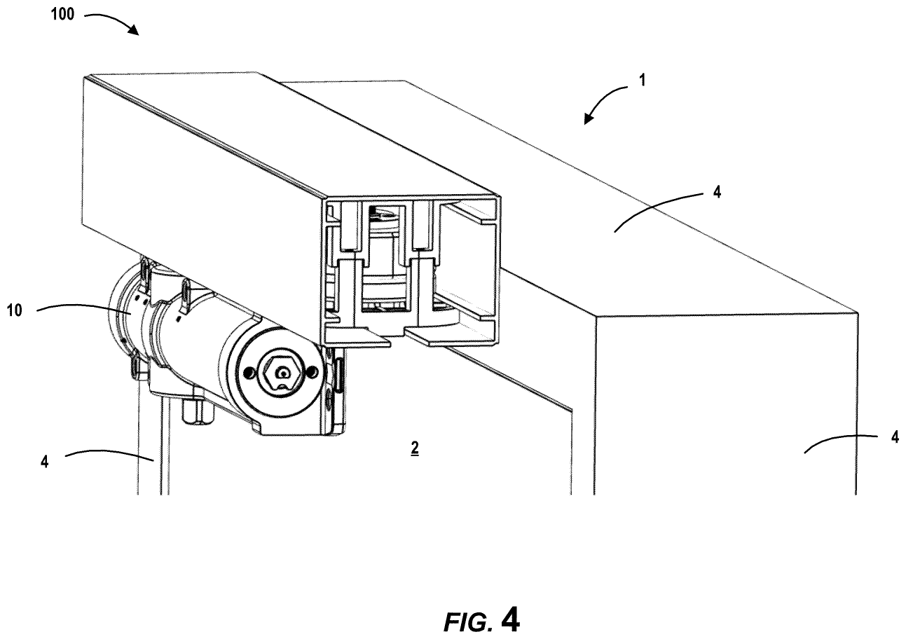

As illustrated in FIGS. 1 through 4, the door closer and assist system 100 is operatively coupled to a door assembly 1. The door assembly 1 may comprise a door 2, a door frame 4, and hinges 6. As further illustrated in FIGS. 1 through 4, the door closer and assist system 100 may comprise a door closer 10 (otherwise described as a door closer system 10, door closer assembly 10, or the like) and a door assist 110 (otherwise described as a door assist system 110, a door assist assembly 110, or the like). It should be understood that while the door closer 10 is illustrated as being operatively coupled to the door 2 and the door assist 110 is illustrated as being operatively coupled to the door frame 4, the door assist 110 may be operatively coupled to the wall 8 (e.g., located above the frame 4). Alternatively, in some embodiments the door assist 110 may be operatively coupled to the door 2, while the door closer 10 may be operatively coupled to the door frame 4 or the wall 8 (not illustrated in the figures). While FIGS. 1 through 4 illustrate that the door closer and assist system 100 is installed on the pull side of the door assembly 1, it should be understood that the door closer and assist system 100 may be located on the push side of the door assembly 1. It should also be understood that the door closer and assist system 100 may be configured for left hand swinging or right hand swinging doors 2.

Moreover, as will be described in further detail herein, the door closer and assist system 100 (e.g., the door closer 10, the door assist system 110, and/or as separate components) may comprise the controller 300 (e.g., described herein as being part of the motor assembly 128), the drive arm assembly 122 (e.g., with one or more drive arms 124), and/or one or more sensors 60 (e.g., a position sensor 62, a force sensor 64, an accelerometer sensor 66, or the like), and/or other like components. As such, it should be understood that these components may be included as part of the other components or may be separate components from the systems and assemblies described herein.

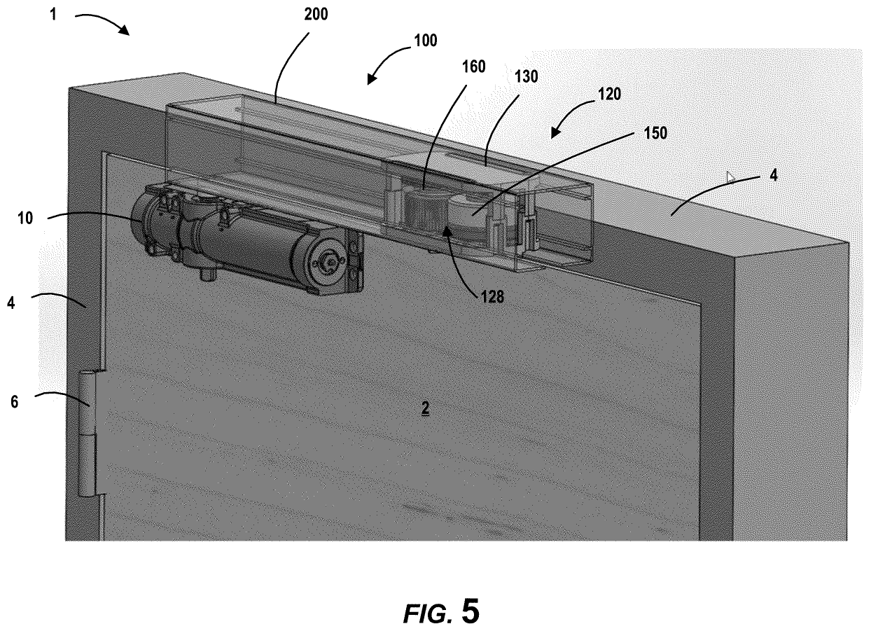

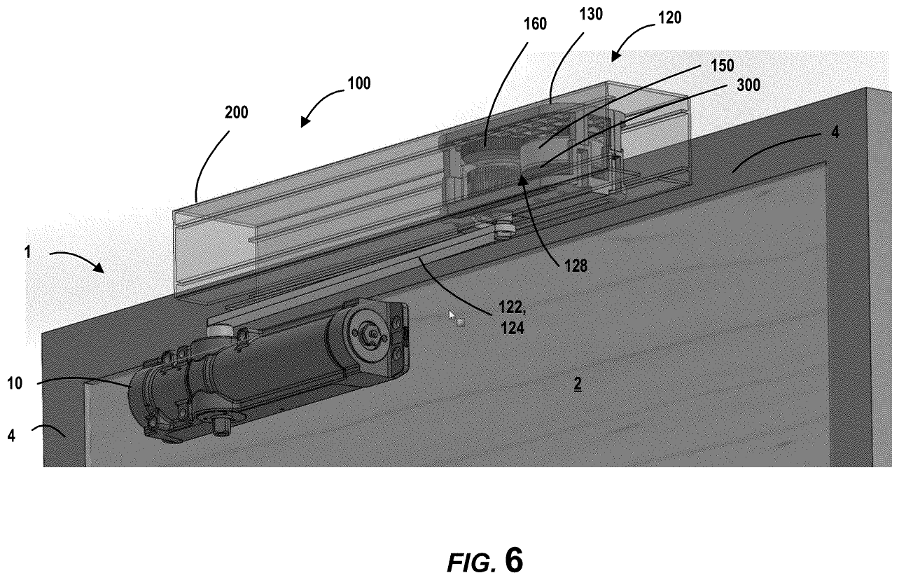

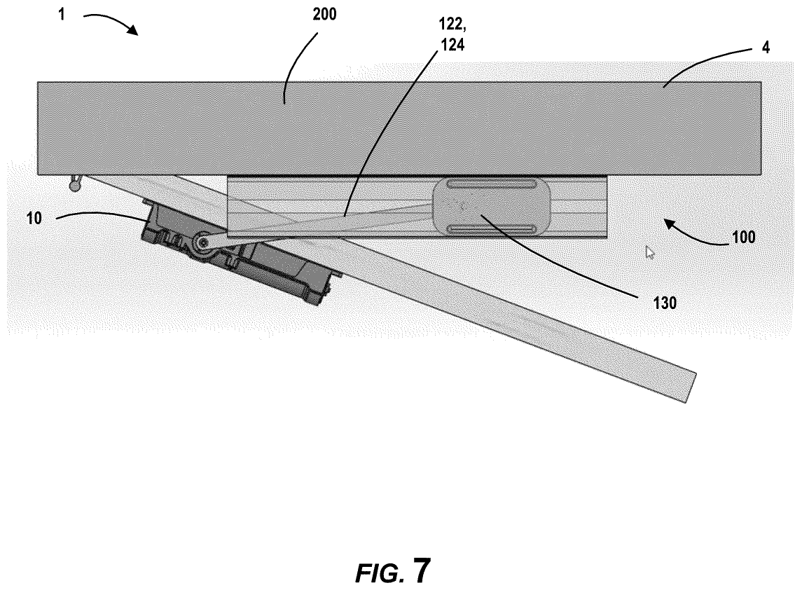

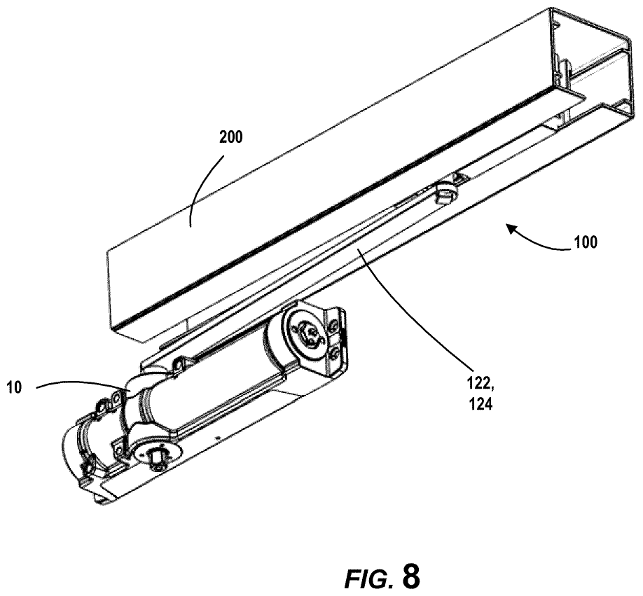

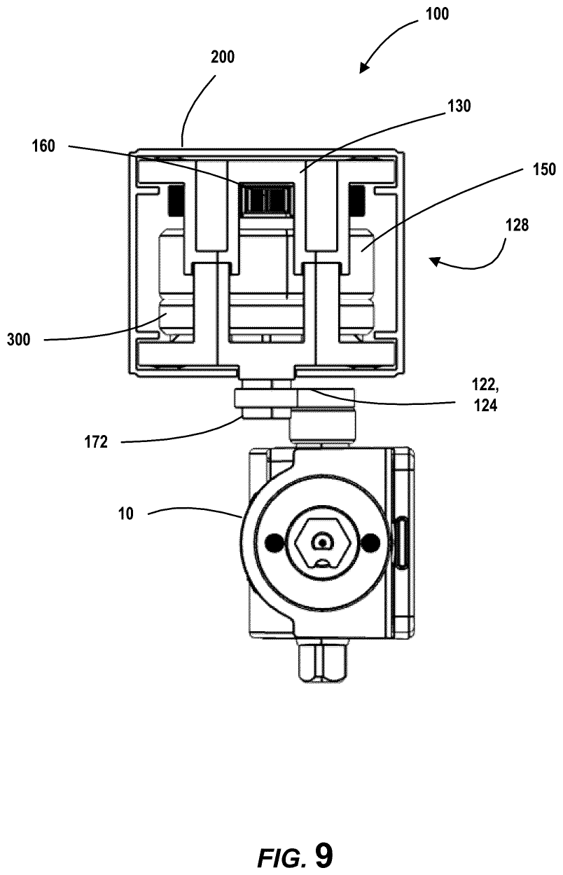

FIGS. 5 through 9 illustrate embodiments of the door assist 110, in accordance with some embodiments of the present invention. The door assist 110 may comprise a drive assembly 120 operatively coupled to a track 200. Generally, the drive assembly 120 comprises a motor and a drive shaft, which mechanically transfers the energy generated from the motor to the drive shaft and ultimately to the door closer 10. In some embodiments, the drive assembly 120 may comprise a drive arm assembly 122 (e.g., comprising one or more drive arms 124), a motor assembly 128, a carriage 130, and a drive shaft 172 (e.g., the drive shaft 170 may be a separate component or may be included as a part of the drive train 160). The motor assembly 128 may comprises a controller 300 (otherwise described as a controller computer system 300, as will be described in further detail herein), a motor 150, and a drive train 160. Moreover, it should be understood that in some embodiments the drive arm assembly 122 (e.g., the one or more drive arms 124, such as single drive arms, multiple drive arms, or the like) may be included as part of the motor assembly 128. As will be described herein, the drive assembly 120 may apply torque to the door closer 10, through the drive arm 124, and slide within the track 200 to aid in opening or closing the door 2.

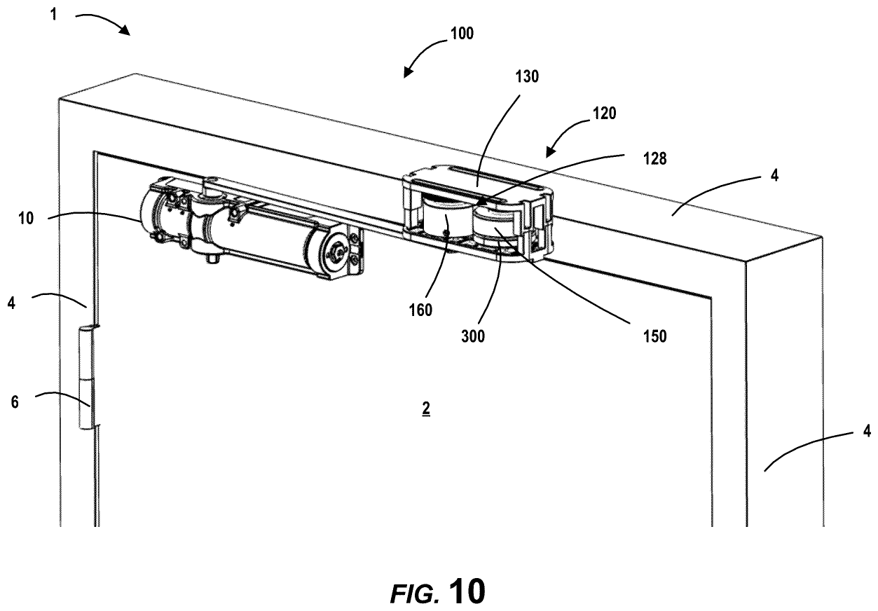

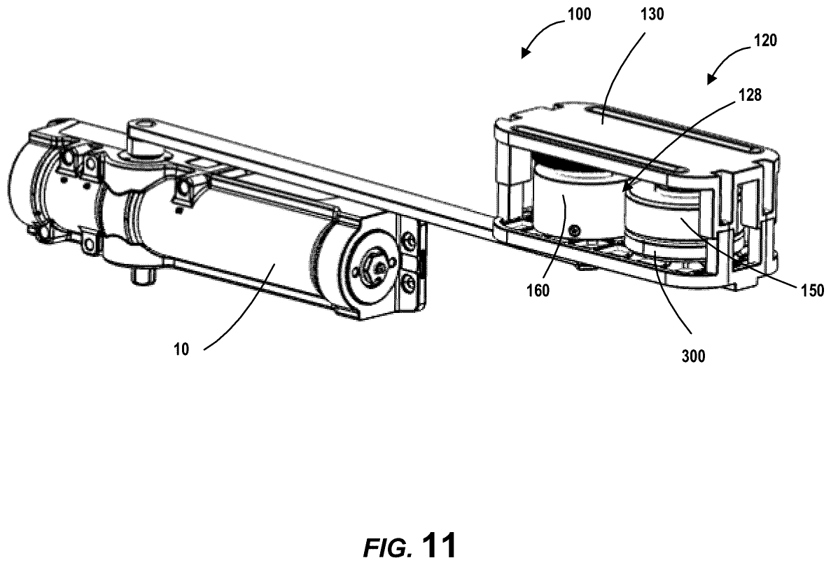

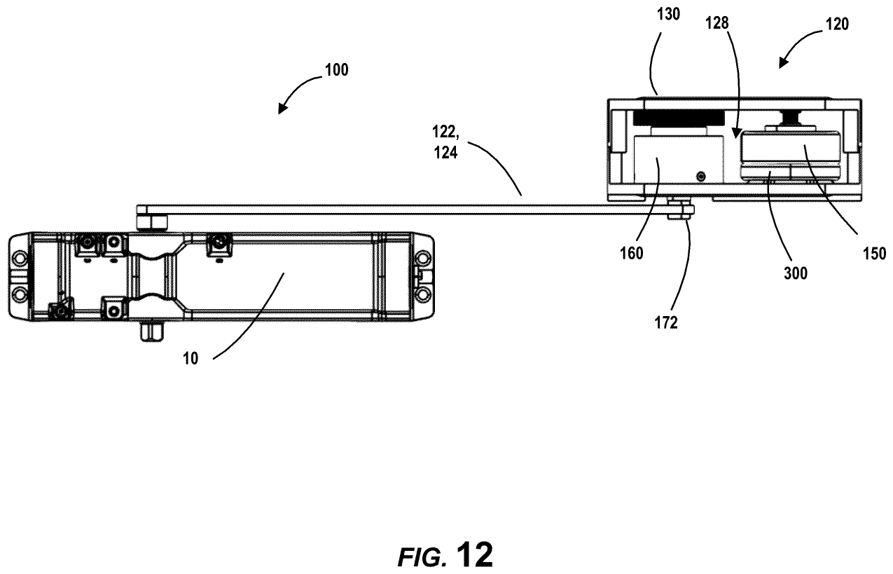

FIGS. 10 through 12 illustrate embodiments of the door closer and assist system 100 with the track 200 removed, and illustrating the components of the drive assembly 120. As illustrated, the carriage 130 is configured to hold at least a portion of the motor assembly 128, such as a motor 150, the drive train 160, and the controller 300. These components will be described in further detail herein; however, the when the controller 300 activates the motor 150, the motor 150 will activate the drive train 160, which in turn provides torque to the drive arm 124 (or other components of the drive arm assembly 122). The drive arm 124 will in turn transfer the torque to the door closer 10 to aid in opening or closing the door depending on the operating parameters set up for the door closer and assist system 100.

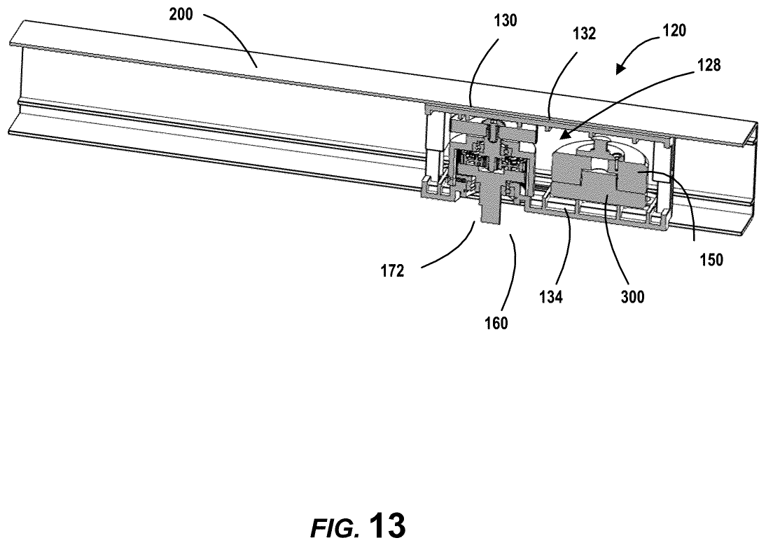

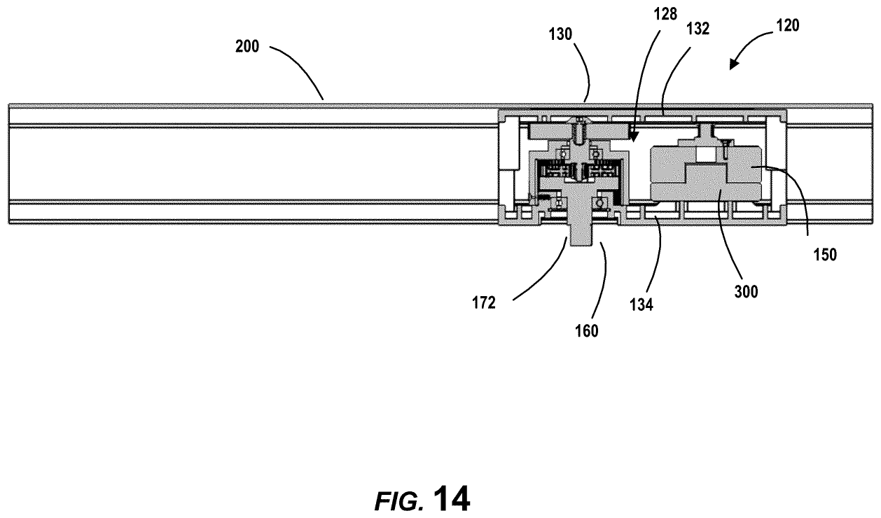

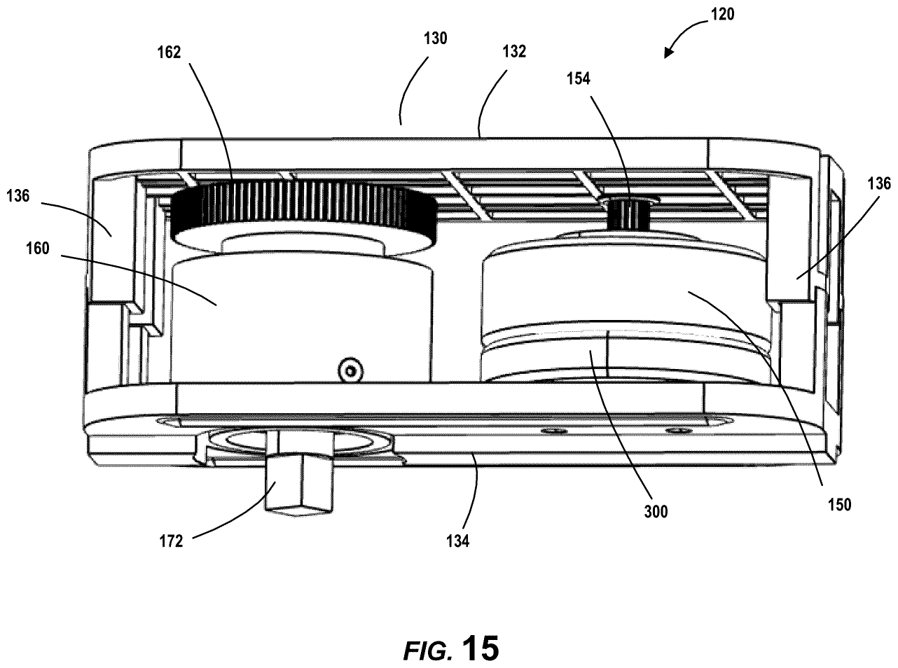

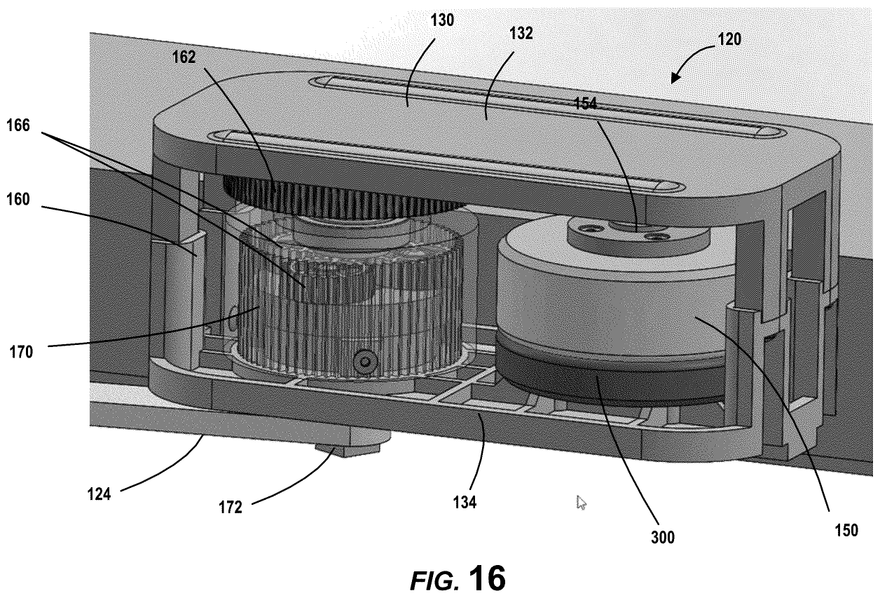

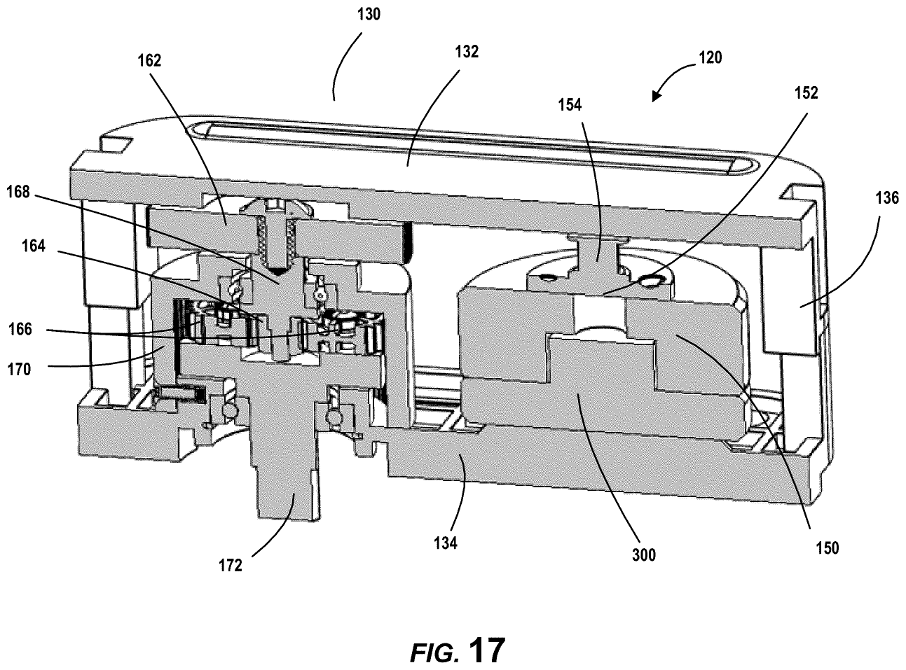

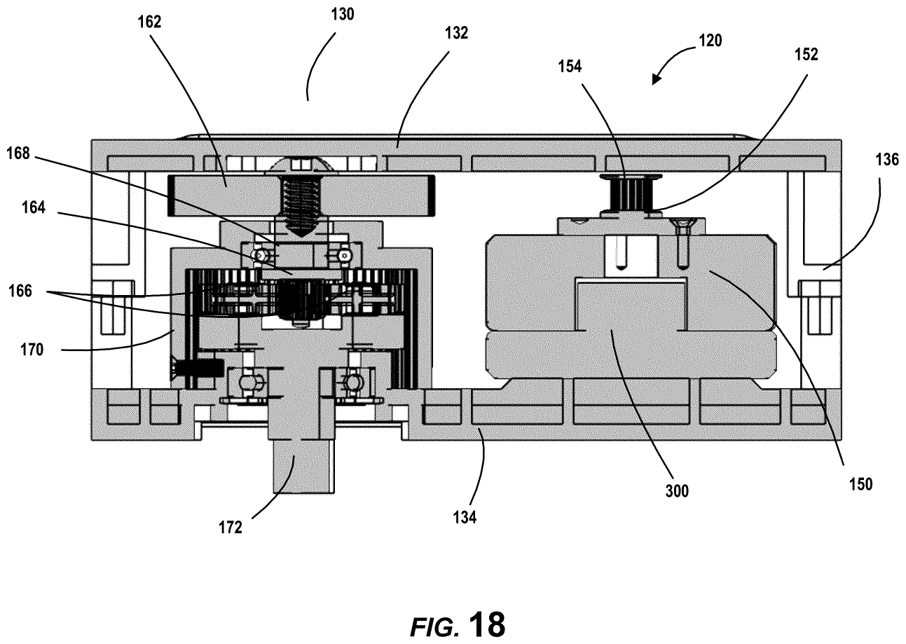

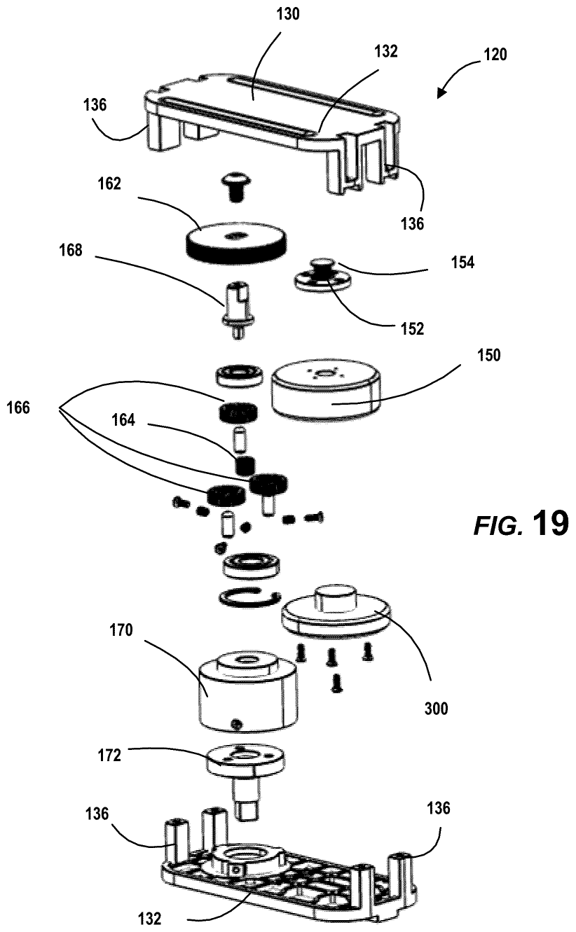

FIGS. 13 through 19 illustrate the components of the drive assembly 120 of the door closer and assist system 100 in further detail. As illustrated in the figures, the carriage 130 may comprise a first carriage portion 132 (e.g., an upper portion, or the like), and a second carriage portion 134 (e.g., a lower portion, or the like). The first carriage portion 132 and the second carriage portion 134 are illustrated as upper carriage and lower carriage portions; however, it should be understood that the portions may be right and left portions, front and back portions, or other like portions or combinations of any of the foregoing (e.g., three, four, five, six, or the like carriage portions). The first carriage portion 132 and the second carriage portion 134 may be operatively coupled through one or more carriage connectors 136. The carriage connectors 136 may be projections (e.g., external or internal, pins, fingers, tabs, apertures, or the like that interact with each other), fasteners (e.g., screws, bolts, nuts, clips, bands, or the like), or other like connectors 136 that are used to operatively couple the two or more carriage portions 132, 134 together. The carriage 130, such as the portions thereof, may have webs (e.g., support webs that create web cavities, or the like) that are used to reduce the weight and/or increase the strength and durability of the carriage 130.

As further illustrated in FIGS. 13 through 19, the carriage 130 may be used to secure at least a portion of the motor assembly 128, such as the motor 150, the controller 300, and/or the drive train 160. The motor 150 may be any type of motor 150, such as a gimbal, brush, brushless, direct drive, linear, servo, stepper, or any other type of motor 150. The motor 150, may have an output shaft 152 and/or a small output gear 154. The output gear 154 may be configured with a toothed belt (not illustrated) that may operatively couple the motor 150 (e.g., directly or through an output shaft 152) and to the drive train 160, as will be discussed in further detail herein. In other embodiments, other types of belts, spools, gears, or the like may be used to transfer torque from the motor 150 to the drive train 160.

The drive train 160 may comprise in input gear 162 that is larger than the output gear 154 of the motor 150. For example, in some embodiments the reduction ratio may range from 4 to 1 through 8 to 1; however, it should be understood that the reduction ratio between the motor 150 and the drive train 160 may be outside of, overlap, or fall within this range. It should be understood that in some embodiments, the reduction ratio may be approximately 6 to 1. The drive train 160 may further comprise a sun gear 164 that is operatively coupled to planetary gears 166. The sun gear 164 may be operatively coupled to the input gear 162 through a gear shaft assembly 168 (e.g., shaft, fastener, flange, bearing, or the like). The planetary gears 166 may be operatively coupled to a ring gear 170. The reduction ratio between the planetary gears 166 and the ring gear may range from 4 to 1 through 8 to 1; however, it should be understood that the reduction ratio within the drive train 160 to the output shaft 172 may be outside of, overlap, or fall within this range. It should be understood that in some embodiments the reduction ratio within the drive train may be approximately 6 to 1. The output shaft 172 extending from the drive train 160 (e.g., as a part of the drive train 160 or operatively coupled thereto) is operatively coupled to the drive arm 124 of the drive arm assembly 122, which is operatively coupled to the door closer 10 to transfer the torque from the drive assembly 120 to the door closer 10 in order to assist in opening and/or closing the door 2.

The total reduction ratio of the transfer of power from the motor 150 to the output shaft 172 of the drive train 160 may be approximately 16 to 1 to 64 to 1; however, it should be understood that the reduction ratio between the motor 150 to the output shaft 172 may be outside of, overlap, or fall within this range. It should be understood that in some embodiments the total reduction ratio may be approximately 42.5 to 1 (e.g., range from 35 to 1 to 50 to 1). The goal of the transfer of the torque from the motor 150 through the drive train 160 to the drive arm 124, and eventually the door closer 10 is to provide a large transfer of torque (e.g., maximize torque), while minimizing the space in which the motor 150 and drive train 160 are packaged. That is, there may be an optimization of the motor size and drive train size to package within the carriage 130 for assembly in the track 200, and the torque that may be transferred from the motor 150 to the door closer 10.

The motor 150 of the motor assembly 128 may be powered any way using any type of power source (not illustrated), including but not limited to battery powered, wired powered, energy harvesting (e.g., solar, kinetic energy, or the like), or the like power source. In some embodiments, the battery may be included in the carriage 130, track 200, door frame 4, wall 8, or the like. Alternatively, or additionally, the wired connection may be hardwired through the wall 8, door frame 4, track 200, or the like. In some embodiments the motor 150 may be wired through a plug that is engaged with an outlet in the wall 8, or the like. When using wired connectors, slack in the wires may be provided to allow the drive assembly 120 to move within the track 200 of the door assist 110. It should be understood that is some embodiments multiple power sources may be utilized, such as battery power and wired and/or wireless power (e.g., charging the battery). In some embodiments, a battery pack may be triple charged using power over internet (POE) charging. Regardless of the type of battery charging, it should be understood that the door assist system 110 may comprise enough battery power such that the door closer and assist system 100 may be rated for fire safety (e.g., provide 8, 10, 12, 14, 16, 18, 20, 22, 24, or the like hours of operation on battery power).

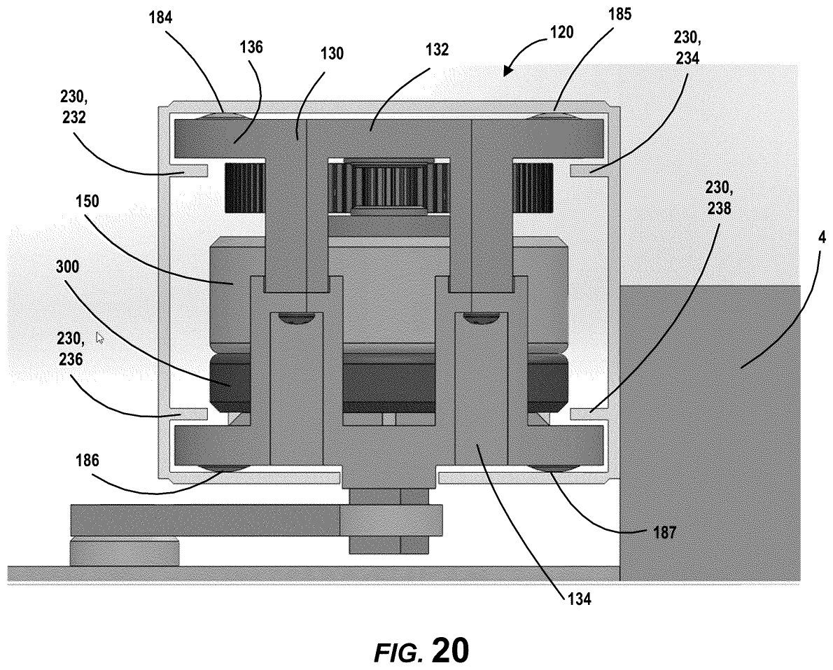

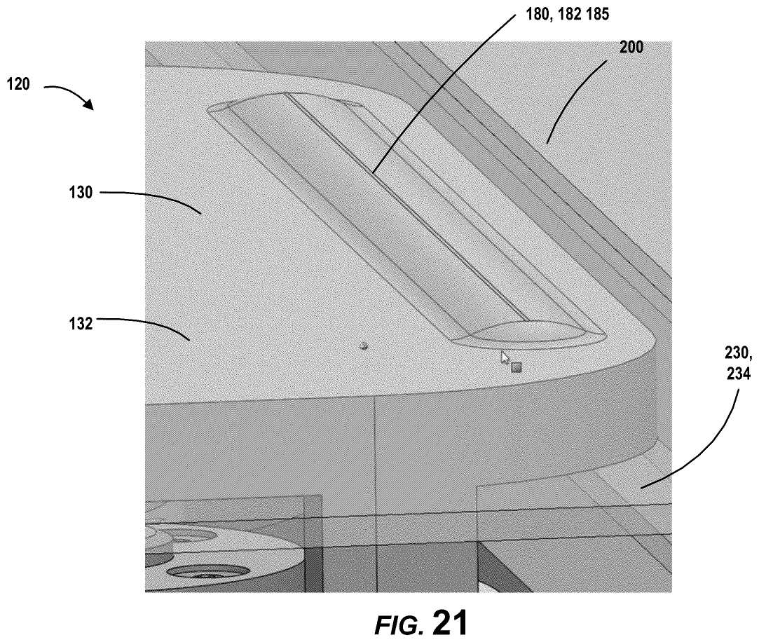

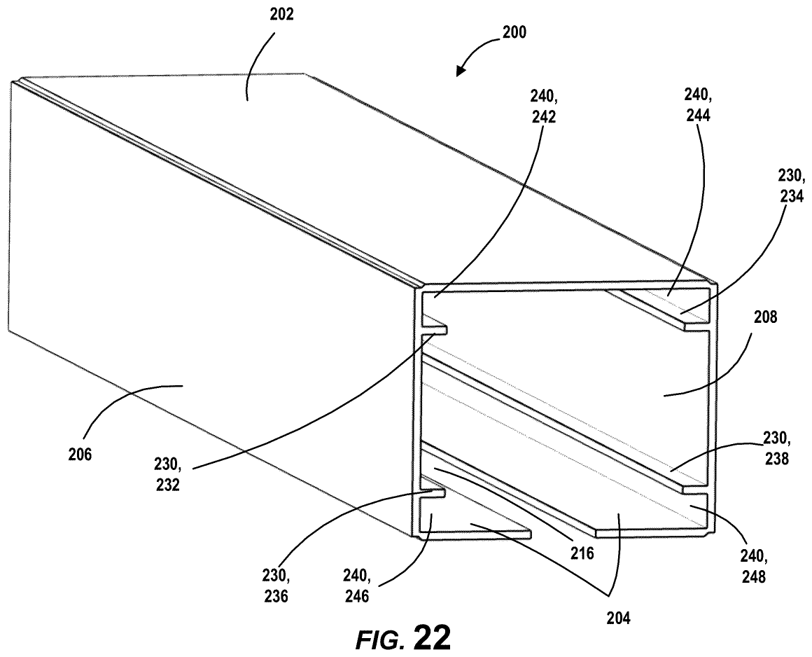

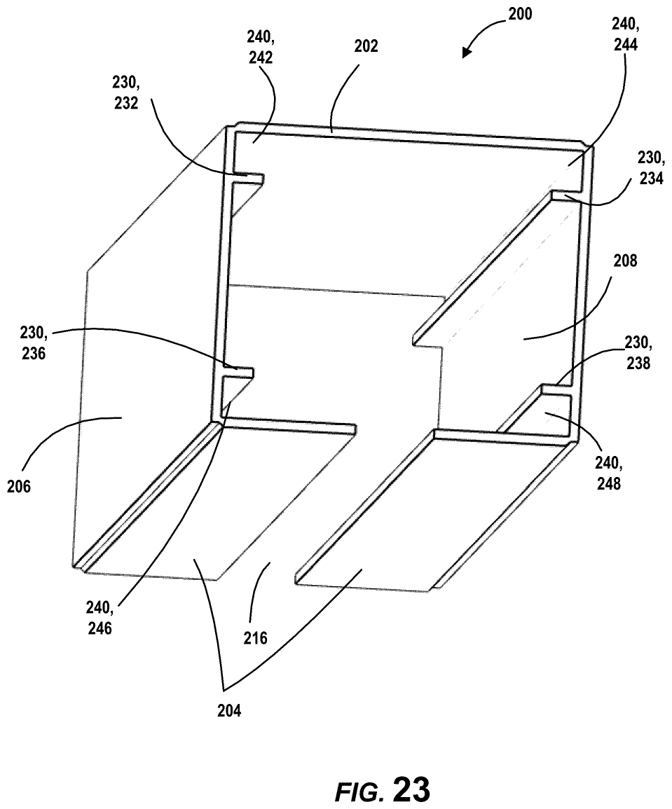

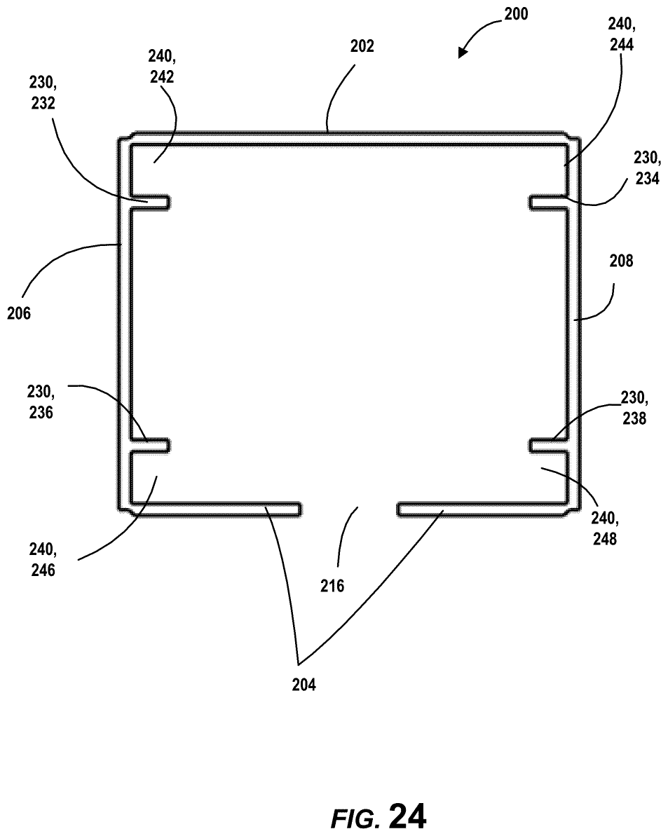

FIGS. 20 through 24 illustrate the track 200 and operative coupling between the track 200 and the drive assembly 120, which allows for the movement of the drive assembly 120 within the track 200. As illustrated in the figures, the track 200 may comprise a top portion 202 (e.g., upper portion), one or more bottom portions 204 (e.g., one or more lower portions), a front portion 206 (e.g., face portion), and a rear portion 208 (e.g., mounting portion). The portions of the track 200 form a track cavity 220 through which the drive assembly 120 travels. The track 200 may further comprise ends 210, such as a first end 212 and a second end 214, which may be open or which may have track end caps (not illustrated) to restrict debris (e.g., dust, objects, or the like from entering the track cavity 220). The track 200 is illustrated as being generally rectangular, but it should be understood that the track 200 may have any type of shape, such as circular, oval, semi-circular, triangular, uniform, non-uniform, combinations thereof, or the like. Moreover, the one or more bottom portions 208 may form a drive shaft aperture 216 (e.g., open ended or closed ended slot, or the like) though which a drive shaft 172 may slide as the drive assembly 120 moves with respect to the track 200.

As further illustrated in FIGS. 20 through 24, the track 200 may comprise one or more holder projections 230 extending into the track cavity 220. The one or more holder projections 230 may extend from the inner surfaces of the track portions, such as from the front portion 206 and/or the rear portion 208. However, in other embodiments, the one or more holder projections 230 may extend from the top portion 202 and/or the bottom portions 204. As such, the one or more holder projections 230 may comprise a first holder projection 232, a second holder projection 234, a third holder projection 236, and a fourth holder projection 238. The one or more holder projections 230 and/or the inner surfaces of the track portions may form holder cavities 240, such as a first holder cavity 242, a second holder cavity 244, a third holder cavity 246, and/or a fourth holder cavity 248. As further illustrated in the figures, the carriage 130 may have one or more carriage projections 140, such as a first carriage projection 142, a second carriage projection 144, a third carriage projection 146, and/or a fourth carriage projection 148 (e.g., extending from the carriage portions). The figures illustrate that the one or more carriage projections 140 extend generally horizontally (e.g., when installed) from the carriage body; however, it should be understood that the one or more carriage projections 140 may extend in any direction. As illustrated in FIG. 20, the first carriage projection 142 may be at least partially located within the first holder cavity 242, the second carriage projection 144 may be at least partially located within the second holder cavity 244, the third carriage projection 146 may be at least partially located within the third holder cavity 226, and/or the fourth carriage projection 148 may be at least partially located within the fourth holder cavity 248. As such, the track 200 may secure the carriage 130 of the drive assembly 120 and allow the carriage 130 to slide within the track 200 (e.g., through the use of the one or more carriage projections 140 and/or the one or more holder projections 230 that form the one or more holder cavities 240). Alternatively, or additionally, in some embodiments the one or more holder projections 230 may extend into carriage cavities (not illustrated) created by the one or more carriage projections 140.

In some embodiment of the invention, the carriage 130 (e.g., outer surfaces of the carriage 130, such as the upper carriage portion 132, the lower carriage portion 134 or other portions, may have one or more sliders 180. The one or more sliders 180 may comprise sliding surfaces 182, rollers (e.g., not illustrated), bearings, or the like. In some embodiments, the sliding surfaces 182 may comprise a first sliding surface 184 (e.g., a first upper sliding surface, or the like), a second sliding surface 185 (e.g., a second upper sliding surface, or the like), a third sliding surface 186 (e.g., a third lower sliding surface, or the like), and/or a fourth sliding surface 187 (e.g., a fourth lower sliding surface, or the like). The sliding surfaces 182 may be extended away from the body of the carriage 130 through the use of protuberances 188, which may be of any shape (e.g., curved, semi-circular, oval, triangular, rectangular, uniform, non-uniform, or the like), but are illustrated as being curved. In some embodiments, the sliding surfaces 182 may be longitudinal strips (e.g., narrow rectangular strips, or other shaped strips) that extend at least a portion of the length of the carriage 130 and/or the protuberances 188 (e.g., along the majority of the length of the carriage 130, or the like). The sliding surfaces 182 are illustrated as longitudinal strips (e.g., lengths longer than widths) in order to reduce the amount of surface area (e.g., in the width of the strips) that contacts the inner surfaces of the track 200. While the sliding surfaces 182 are illustrates as longitudinal strips it should be understood that the sliding surfaces may be any surface of any shape (e.g., any length, width, any uniform, non-uniform, or the like shape). It should be further understood that while the strips are illustrated as being continuous, it should be understood that the strips may be discontinuous (e.g., have separations along the length of the strips). The one or more sliding surfaces 182 may be made of any material with a low coefficient of friction (e.g., aluminum, Teflon, UHMW, fiberglass, PTFE, or the like) in order to improve the sliding of the carriage with respect to the track 200. Moreover, in some embodiments, coatings may be applied to the sliding surfaces 182, the one or more carriage connectors 136, the holder projections 230, and/or other surfaces of the track 200 in order to improve the sliding of the carriage 130 within the track 200.

While the one or more sliders 180 (e.g., sliding surfaces 182, or the like) are illustrated as being located on the upper carriage portion 132 and the lower carriage portion 134, which are configured to engage the inner surfaces of the top portion 202 and lower portions 204 of the track 200, it should be understood that the sliding surfaces 180 may be located on other portions of the carriage 130 to interact with other surfaces of the track 200 (e.g., to interact with the inner surface of the face portion 206 and/or rear portion 208).

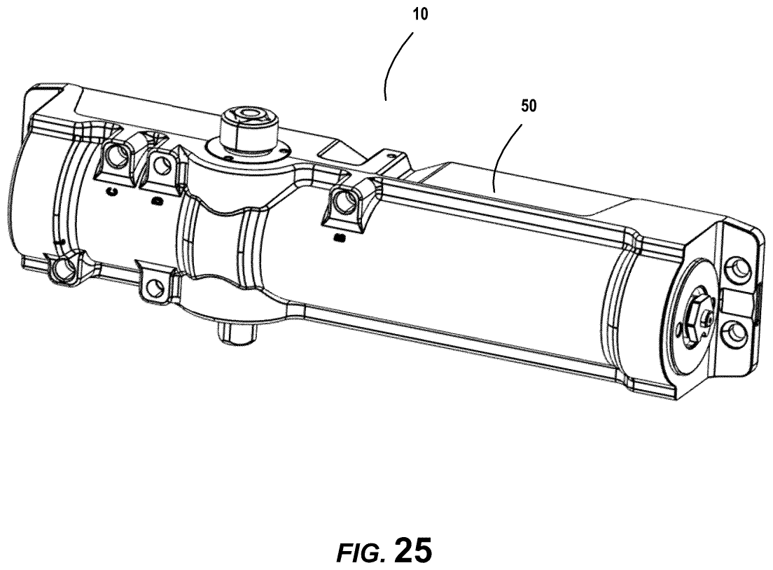

FIGS. 25 through 27 illustrate one embodiment of a door closer 10 of the door closer and assist system 100 described herein. The door closer 10 comprises a casing 50 that is shown mounted to the door 2; however, in other embodiments the casing 50 may be mounted to the door frame 4 and/or a wall 8 adjacent the door 2, or within a floor, or the like. The casing 50 is typically mounted in a particular orientation, such as horizontally, with respect to the horizontal top of the door 2 and/or horizontal top portion of the door frame 4. Alternatively, in other embodiments, the casing 50 may be mounted vertically or at another suitable angle with respect to the horizontal top of the door 2. In some embodiments the casing 50 may comprise a cover that is operatively coupled to a back plate, and the back plate is operatively coupled to the adjacent surface (e.g., door 2, door frame 4, wall 8, or the like). The casing 50 at least partially surrounds and encloses the components of the door closer 10 to reduce debris (e.g., dirt, dust contamination, or the like), and to provide a more aesthetically pleasing appearance. It is understood that in some embodiments of the invention, the door closer 10 may be concealed within the door 2, the door frame 4, in a wall 8 adjacent the door 2, or the like.

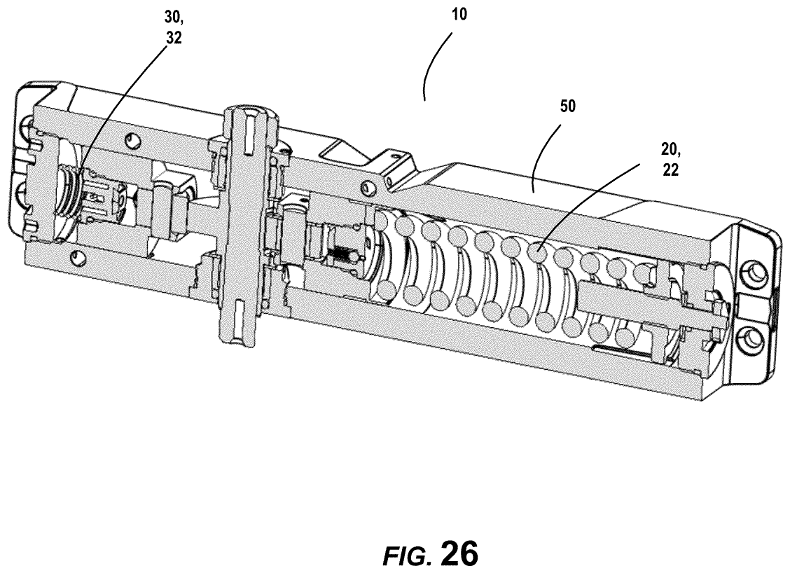

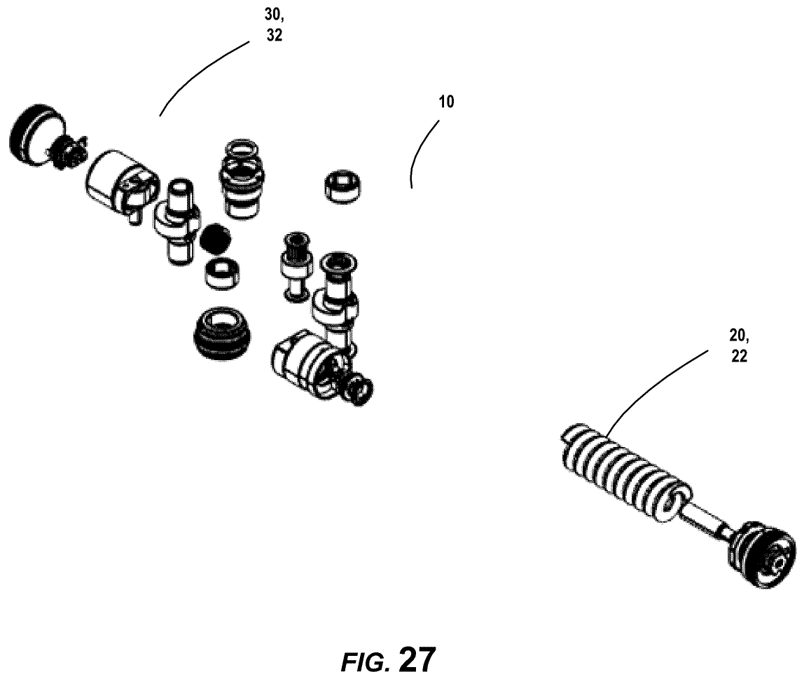

As illustrated in FIGS. 26 and 27, the door closer 10 may comprise a biasing member 20 (e.g., a spring 22, or the like), a damper 30 (e.g., an actuator or piston—hydraulic actuator, pneumatic actuator, or the like, a second spring 32, or the like). During closing, the biasing member 20, such as the spring 22 (e.g., loaded from manual opening beyond its pre-loaded rested position while the door is closed) begins to return to its resting position (e.g., closed position), and in some embodiments a damper 30 (e.g., second spring 32, or the like) is engaged during closing to control the speed at which the biasing member 20 (e.g., the spring 22) closes the door 2. As will be described in further detail herein, during closing of the door 2, as the loaded biasing member 20 (e.g., spring 22) is moving the door 2 towards a closed position, the door assist 110 may be activated in order to aid in closing the door 2 with the amount of force defined by the operating parameters (e.g., greater than or equal to 5 lbs of force to close the door, or the like).

As will also be discussed in further detail herein, when the door 2 is to be opened or when the door 2 in the process of opening the biasing member 20 is being loaded manually by the user opening the door 2. Depending on the operating parameters set for the door closer and assist system 100 (e.g., less than or equal to 5 lbs of force to open the door), the door assist 110 previously discussed herein may be activated in order to aid the door closer 10 in closing the door 2 and/or aid the user in overcoming the closing force set for the door closer 10 in order to open the door.

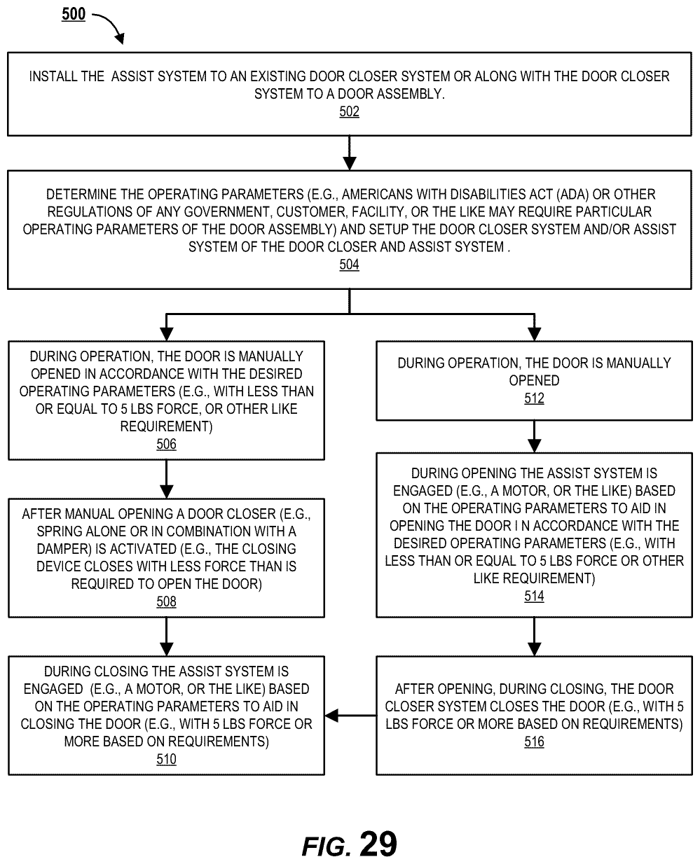

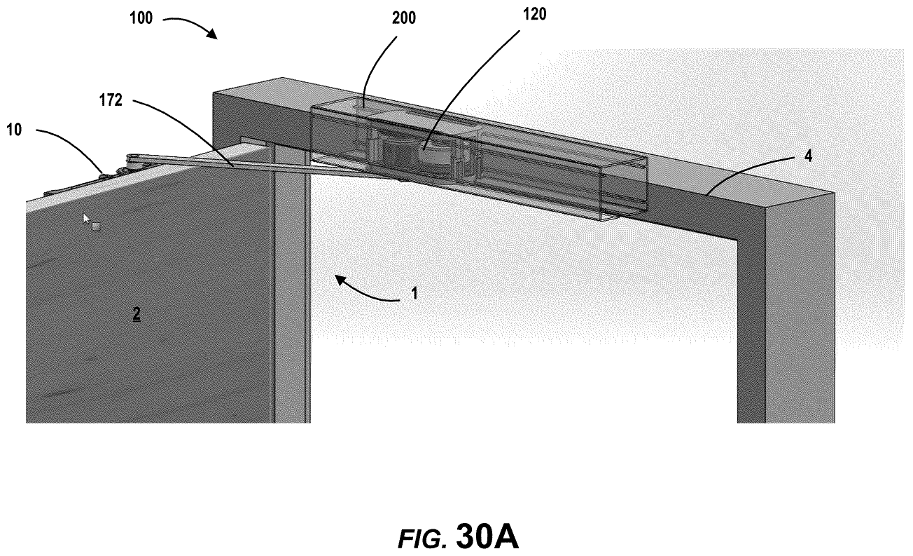

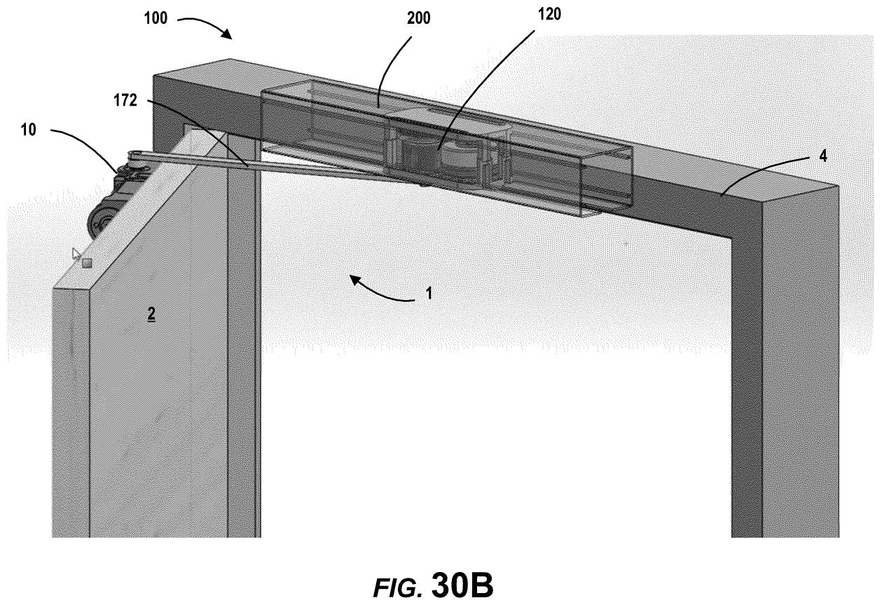

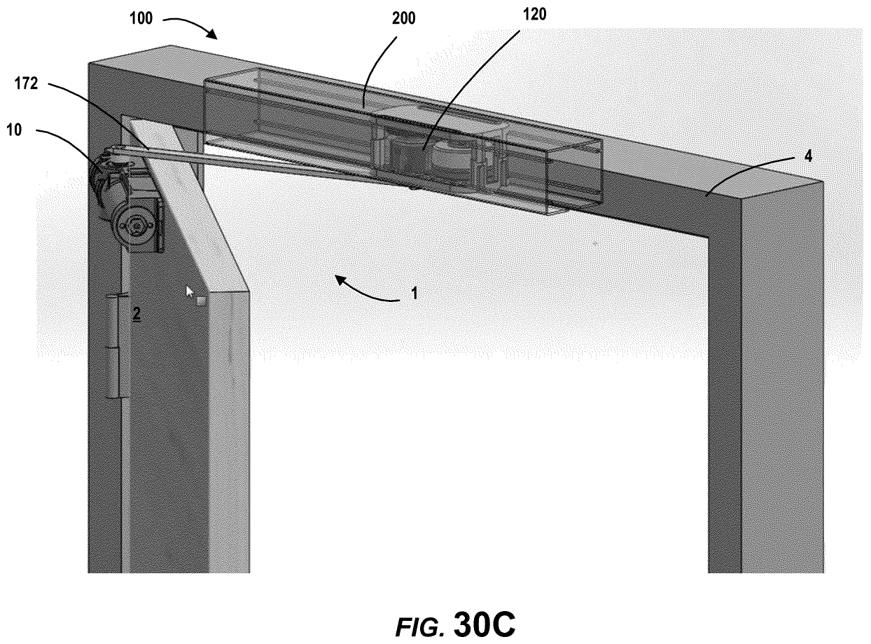

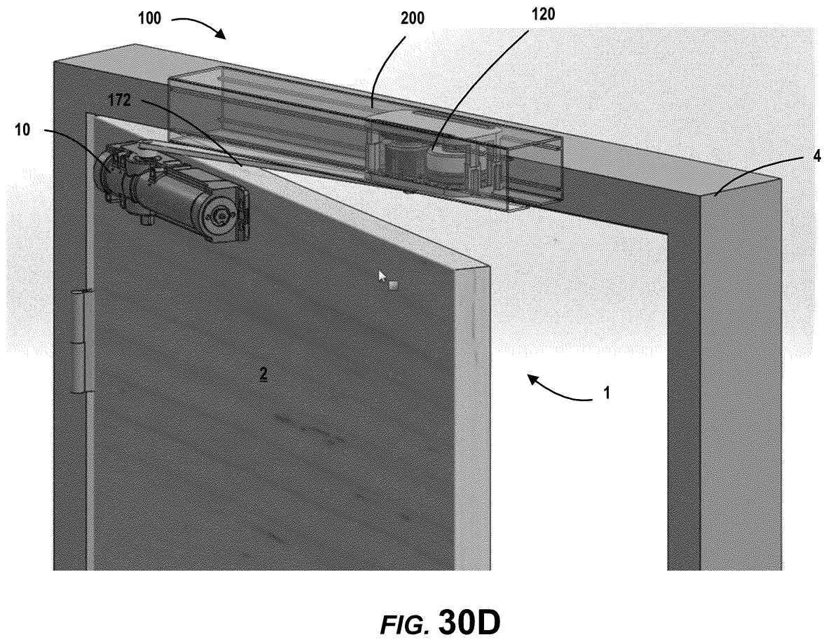

The door assist system 110 may be activated based on a controller 300 communicating with one or more sensers 60 (e.g., a position sensor 62, a force sensor 64, an acceleration sensor 66, or the like), as will be described in further detail with respect to FIGS. 29 through 30D. As such, it should be understood that the operating parameters for the door closer and assist system 100 may be adjusted based on the use of a controller 300 and/or one or more sensors 60 during or after the door assist system 110 is installed (e.g., locally at the door closer and assist system 100 and/or remotely through communication with the controller 300).

As will be discussed in further detail herein with respect to FIGS. 29 through 30D, the controller 300 will activate the motor 150 to apply additional force for opening or closing the door 2 (e.g., increasing the force for closing and/or opening by applying torque to the door closer during closing and/or opening). The motor 150 of the door assist 110 may be activated when the door is being opened, when a particular defined position of the door 2 is reached (e.g., at a particular angle from the closed position), when the door is closing, when the speed or acceleration of the door falls below a particular target speed or acceleration, when the force for opening or closing the door falls outside of the threshold, or the like. Moreover, should the door 2 reach the closed position, reach a fully opened position, change from moving towards a closed position to an open position (e.g., manually opened by a user during closing, or the like), change from moving towards an open potion to a closed position (e.g., manually closed by a user during opening, or the like), be in the closed position and receive an indication that the door is going to be opened (e.g., a sensor 60 identifies a user is in the zone of the door, a handle is activated, an activation switch is pushed, or the like), or begin to be moved from the closed position to the open position (e.g., as detected by a sensor 60, or the like), then the controller 300 may activate and/or deactivate the door assist 110 in order to control the door 2 based on the operating parameters set for the operation of the door 2. In some embodiments, the identification that the door 2 is about to be opened may be based on a user engaging (e.g., moving) a door handle (e.g., push bar, rotating a handle, or the like), a user being identified in a particular zone (e.g., through the use of a pressure pad, camera, motion detector, or other like detection sensor), or other like detection method.

As such, the door assist system 110 may be utilized at any point in time or location of the door 2 as it is opening, closing, or at rest (e.g., in any resting open position or in a resting closed position) in order to aid in opening or closing a door 2 to meet the desired requirements (e.g., ADA compliance, or other requirements discussed herein). It should be understood that in some embodiments the force required to open and/or close a door may be set to a static value or the force may be dynamic as the door is moving to different positions and/or as different conditions are identified with respect to the movement of the door 2. For example, the biasing member 20 (e.g., the spring 22 pre-load) may be set based on the desired opening and/or closing force. For example, the door opening force may be set to be less than or equal to a set force (e.g., 5 lbs or less of opening force, or other force based on the requirements of any entity). In this case, due to the loss of efficiency, the force at which the door 2 closes will be less than the set force (e.g., 5 lbs or less, or other force based on the set force above), which is typically about 50% of the force required to open a door. In this case the door assist system 110 may be set to aid in closing the door 2 (e.g., so the door 2 can be closed with 5 lbs or more force during closing, or other force based on the requirements of any entity). In other examples, the door closing force may be set such that the door 2 may be closed only by the door closer 10 after the door 2 is opened (e.g., the door may be closed with 5 lbs or more of closing force, or other force based on the requirements of any entity). However, the force required for opening the door 2, when the closing force is set, is greater than the closing force. As such, in order to open the door 2 as desired (e.g., with 5 lbs or less of opening force, or other force based on the requirements of any entity), the door assist system 110 may be activated during opening.

Additionally, in some embodiments, should the door 2 be opening and/or closing, but an object (e.g., user, animal, or inanimate object) is located in the path of the door 2 (e.g., identified through the use of a sensor 60), the door assist system 110 may be activated and/or deactivated in order to aid is stopping, slowing, reversing, or the like the operation of the door 2. Alternatively, or additionally, should conditions exist (e.g., wind, HVAC, other static pressure issues, mechanical issues, or the like) that increase the forces exerted on the door 2, the door assist system 110 may be activated and/or deactivated in order to aid in opening and/or closing the door.

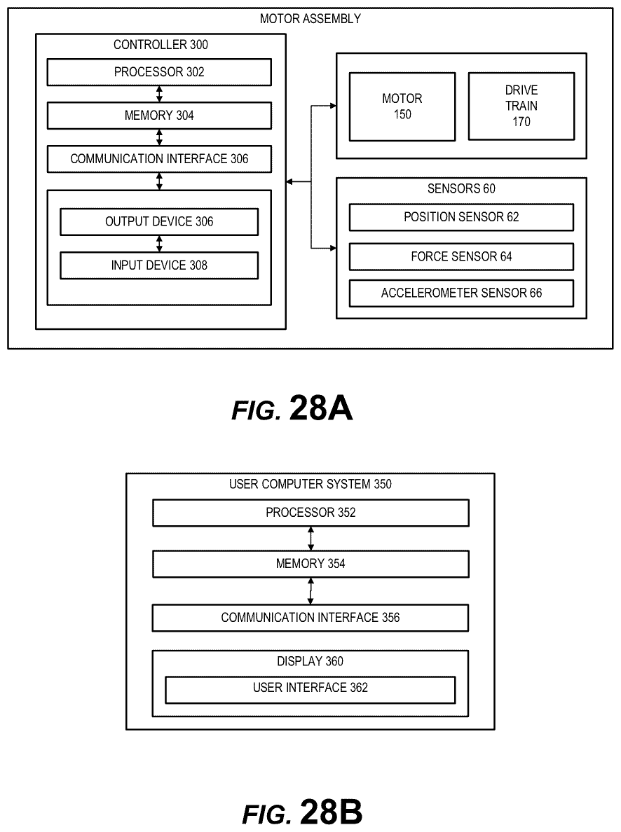

As illustrated in FIGS. 28A and 28B, the controller 300 of the drive assembly 120 may be in communication with the motor 150 and/or one or more sensors 60 to control the operation of the door assist system 110 and functions to transmit appropriate control signals to the motor 150 to aid in closing and/or opening the door 2 based on the position of the door 2, the force at which the door is closing or opening, the speed and/or acceleration at which the door 2 is closing or opening, should be the door 2 be in a static stopped position and not moving for a period of time, or the like. By way of example, the controller 300 may control the motor 150 as the door 2 is closing, opening, in a closed position, in a static position. Moreover, in some embodiments, the controller 300 of the door assist system 110 may communicate with one or more user computer system 350 to set-up and/or adjust the operation of the door assist system 110.

In some embodiments of the door closer and assist system 100, and the methods provided herein, information is sent to and received from the controller 300 of the door assist system 110, which allows for controlling, monitoring and adjusting the operation of the door assist system 110 and/or provides the functionality described herein. As illustrated in FIG. 28A, the controller 300 of the door closer and assist system 110 comprises one or more processors 302, one or more memories 304 (having computer readable code stored thereon), one or more communication interfaces 306, and/or one or more output and/or input devices 306, 308, all of which may be operatively coupled to each other, in order to operate the door closer and assist system 100 as described herein.

As used herein, a “processor” generally refers to a device or combination of devices having circuitry used for implementing the communication and/or logic functions of a particular system. For example, the processor 302 may include one or more digital signal processor devices, microprocessors, and/or microcontrollers and other support circuits and/or combinations of the foregoing. Control and signal processing functions of the system are allocated between these processing devices according to their respective capabilities. Some of the one or more memories are non-volatile, storing configuration information and program code. The controller 300 may further include functionality to operate one or more software programs based on computer-executable program code, which may be stored in the one or more memories. As the phrase is used herein, the controller 300 may be “configured to” perform a certain function in a variety of ways, including, for example, by having one or more general-purpose circuits perform the function, by executing particular computer-executable program code embodied in computer-readable medium, and/or by having one or more application-specific circuits perform the function.

The door assist system 110, such as the controller 300, can include computer program code which, when executed by the processor, causes the door assist system 110 (e.g., the motor 150, the sensors 60, or the like) to perform as described herein. A computer program product can include a medium with non-transitory computer program code that when executed causes the door assist system 110 to operate as described herein. The present disclosure may be embodied as a method, device, article, system, computer program product, or a combination of the foregoing. Any suitable computer usable or computer readable medium may be utilized for a computer program product to implement all or part of the systems. The computer usable or computer readable medium may be, for example but not limited to, a tangible electronic, magnetic, optical, electromagnetic, or semiconductor system, apparatus or device. More specific examples of the computer readable medium may include, but is not limited to, the following: a portable computer diskette, a hard disk, SIM chip, a random-access memory (RAM), a read-only memory (ROM), an erasable programmable read-only memory (EPROM or Flash memory), a portable compact disc read-only memory (CD-ROM), or an optical storage device.

Computer program code for carrying out operations of the present invention or for assisting in the carrying out of a method according to an example embodiment of the invention may be written in an object oriented, scripted or unscripted programming language such as Java, Peri, python, C++, or the like. However, the computer program code for carrying out operations of the present disclosure may also be written in conventional procedural programming languages, such as the “C” programming language or similar programming languages. The computer program code may also be written in HTML5 or similar languages that are commonly used for applications or “apps” intended to be run on mobile computing devices such as smart phones, tablets, and the like. While specific examples of programming languages are described herein, these examples are not exhaustive, and the computer program code may be written in any suitable programming language.

Computer program instructions may be provided to the controller 300 to produce a machine, such that the instructions, which execute via the processor of the controller 300, create a device for implementing the functions necessary to carry out the embodiments as described herein. Computer program instructions may also be provided as firmware for an embedded controller 300 or a plurality of embedded controllers 300.

The controller 300 includes, or is in communication with, an onboard communication interface, such as a wired communication interface and/or a wireless communication interface (e.g., wireless communication chip) that communicates with a user computer system 350 (e.g., mobile devices, such as remote control, smartphone, smart wearable device—watches, glasses, laptops, desktops, or the like computing devices) or an access control device (e.g., badge, fob, electronic key, card, or the like) over a wireless connection. It should be understood that the wireless communication may occur over any type of wireless network, or such communication may occur directly between the controller 300 and the user device (e.g., user computer system, access control device, or the like) such that the controller 300 does not require access to an external network (e.g., external Wi-Fi network, the cellular network or other external network). As used herein, the term “directly communicates” means that the user device (e.g., user computer system, access control device, or the like) communicates with the on-board communication interface without an intervening network such as an external wireless network (e.g., external Wi-Fi network, LAN or WAN, or other external wireless protocol). In some embodiments, the controller 300 may be directly coupled to, and may directly communicate with, user device over relatively short distance using the wireless communication interface. The controller 300 may be coupled to the user device via the wireless communication interface that communicates using a wireless networking protocol, such as WiFi based on the institute of Electrical and Electronics Engineers (IEEE) 802.11 standards, Bluetooth short-wavelength UHF radio waves in the ISM band from 2.4 to 2.485 GHz, 5 GHZ, 6 GHz, a proprietary communication interface or other wireless access technology whether or not described herein.

While in some embodiments, the communication interface communicates directly with the user device over a short range via a wireless connection such as WiFi, Bluetooth or other wireless access technology, a wireless connection may operate over long or intermediate ranges and may include intervening networks. In this regard, the door assist system 110, such as the controller 300, may comprise a transceiver that is configured to operate with one or more air interface standards, communication protocols, modulation types, and access types to communicate with user devices. By way of illustration, the door assist system 110, such as the controller 300, may include a transceiver that may be configured to operate in accordance with any of a number of first, second, third, fourth, fifth, and/or the like generation communication protocols and/or the like. For example, the door closer 10 may be configured to operate in accordance with second-generation (2G) wireless communication protocols IS-136 (time division multiple access (TDMA)), GSM (global. system for mobile communication), and/or IS-95 (code division multiple access (CDMA)), or with third-generation (3G) wireless communication protocols, such as Consolidated Mobile Telecommunications System (UMTS), CDMA2000, wideband CDMA (WCDMA) and/or time division-synchronous CDMA (TD-SCDMA), with fourth-generation (4G) wireless communication protocols, with 1, TE protocols, with 3GPP protocols, with fifth-generation (5G) wireless communication protocols, with six-generation (6G) wireless communication protocols, with tenth-generation (10G) wireless communication protocols, and/or the like. The door assist system 110 may also be configured to operate in accordance with non-cellular communication mechanisms, such as via a wireless local area network (WLAN) or other communication/data networks.

Moreover, like the controller 300, one or more user computer systems 350 may be utilized to communicate with the controller 300, in order to set-up, change the operating parameter, monitor, control, or the like, the door assist systems 110 (e.g., directly, remotely, or the like). As such, as illustrated in FIG. 28B, the user computer system 350 may have the same or similar components as the controller 300, such as one or more processors 352, one or more memories 354 (having computer readable code stored thereon), one or more communication interfaces 356, and/or one displays 360 (e.g., on which a graphical user interface 362 may be displayed), all of which may be operatively coupled to each other, in order to communicate with the controller 300, as described herein. Additionally, the user computer system 350 may comprise one or more output and/or input devices, as described with respect to the controller 300 of the door assist system 110. Moreover, it should be understood that in some embodiments the controller 300 may have a display 360, on which a user interface may be displayed.

The controller 300 and/or the user devices (e.g., user computer system 350, access control devices, or the like) may be part of an overall control system which may include one or more input and/or output devices that may be operatively coupled to the controller 300 to allow for the set-up, changing operating parameters, and/or monitoring of the door assist system 110. The input devices 308 may include physical inputs (e.g., keys, buttons, a touchscreen, speaker, or other like inputs that allow for a selection of the operation of the door closer and assist system 100). The input devices 308 may further include ports through which communication may be made (e.g., USB, USB-C, microUSB, lighting, or other like ports). The output devices 306 may include devices (e.g., screens, such as an LCD screen, touchscreen, or the like, microphones, or the like) that provide information to a user (e.g., an installer, operator, technician, or the like). In still other embodiments, the input and/or output devices 306, 308 may be incorporated into a user computer system 350 (e.g., a mobile device, such as remote control, smartphone, computer, laptop, tablet, or the like), and such user computer system 350 may communicate wirelessly with the controller 300 over a wireless connection or may otherwise be connected through a wire (e.g., USB connection, or the like).

It should be further understood that the input and/or output devices operatively coupled to the controller 300 and/or the user computer system 350 may utilize one or more user interfaces 362 (e.g. web pages, application interfaces, or the like) that are accessible directly on the one or more input and/or output devices in the door assist system 110, and/or on the user computer system 350 that communicates with the controller 300 over the wireless communication interface. The user interfaces can be used for setup, diagnostics, input and output programming, settings, or the like related to the operating parameters and/or operation of the door closer and assist system 100 and/or the components thereof. As such, it should be understood that the one or more input and/or output devices, and/or the user computer systems 350 may allow for programing of the door assist system 110 by setting and/or storing the operating parameters for the operation of the door assist system 110 (e.g., the motor 150, the one or more sensors 60, or the like) to aid in opening and/or closing the door 2, as described herein.

FIG. 29 illustrates a process flow 500 for the installation and operation of the door closer and assist system 100, in accordance with embodiments of the present disclosure. As illustrated by block 502 of FIG. 29, a user (e.g., installer, or the like) may install the door assist system 110 to an existing door closer 10 (e.g., any type of closer of any entity), as a retrofit assembly to create the door closer and assist system 100 described herein. As further illustrated in block 502, the user may install the door assist system 110 along with a door closer 10 (e.g., any type of closer of any entity) to a door assembly 1. As previously discussed herein, one of the door closer 10 or the door assist 110 may be operatively coupled to a door 2, while the opposing assembly is operatively coupled to the door frame 4 and/or the wall 8.

Block 504 of FIG. 29 further illustrates that the operating parameters for the door closer 10 and the door assist 110 are determined. For example, the operating parameters for the door closer 10 and/or door assist 110 of the door closer and assist system 100 may be based on the Americans with Disabilities Act (ADA), other regulations of any government, customer, facility, or the like which may require allowing for the opening of a door 2 with a force that is less than or equal to the closing force of the door 2. As further illustrated in block 504 of FIG. 29, the closing force of the door closer 10 may be set manually (e.g., by a user changing the spring force of the door closer, or the like) or may be set automatically (e.g., through an electronic setting, or the like). Furthermore, the operating parameters of the door assist system 110 may be set based on the setting of the closing force of the door closer 10. That is, the operating parameters may be set to allow the door assist system 110 to aid in opening the door 2 and/or closing the door 2. For example, the door assist system 110 may be set for activation during opening and/or closing when the door begins to open or close, when the door reaches an open or closed position (e.g., particular angle), when the door is moving below a set force, speed, or acceleration during opening and/or closing, or set for other like operating parameters.

The user (e.g., installer installing the door 2, door closer 10, and/or door assist 110, technician servicing the foregoing, or the like) may set the operating parameters in any number of different ways, such as manually through input and/or output devices within the door closer and assist system 100 (e.g., a touchscreen, a port, or the like), a wired connection between the controller 300 and a user computer system 350 and/or wireless communication between the controller 300 and/or the user computer system 350. Alternatively, it should be understood that the operating parameters may be pre-defined before the door closer and assist system 100 is installed, and as such, the user (e.g., installer) may only have to select one of the pre-defined set of operating parameters. Alternatively, and/or additionally, the door closer and assist system 10 may be set by the provider of the door closer and assist system 100 before the door closer and assist system 100 is shipped, in order to reduce the installation requirements of the user (e.g., the door closer and assist system 100 may be installed without having to set the operating parameters).

As such, in some embodiments the force settings for opening and closing the door 2, the speed settings for opening or closing the door 2 (e.g., how long it takes to close the door), acceleration settings for opening or closing the door 2 (e.g., how fast the door closes at different and/or between different positions), and/or the time required to change the force (e.g., provide additional force or reduce the force) as operation of the door 2 changes, may be selected by the user. Additionally, and/or alternatively, the user may select pre-determined closing curves that provide the settings for opening and/or closing the door 2. Additionally, and/or alternatively, the operating parameters may be set automatically by entering a setup mode, manually opening the door, allowing the door to close, and allowing the controller 300 to automatically determine the operating parameters needed to close the door 2 based on one or more door sensors 60 and/or stored force and/or position curves. For example, the force required to open the door 2 may be identified (e.g., based on a force sensor). Moreover, the speed and position of the door 2 as it is closing may be determined at multiple closing positions (e.g., at different angles during closing). Furthermore, when the door 2 stops moving the controller 300 may determine the position of the door 2 when it stops. The information determined from the manual opening, the closing of the door 2 at multiple positions, and the location of the door 2 when it stops may be used to automatically set the opening force and the closing force (e.g., by adjusting when the door assist system 110 is activated and/or how much torque is applied).

The user installing (or servicing) the door 2 and/or door closer and assist system 100 may manually open the door 2 and allow the door 2 to close a plurality of times (e.g., two or more times) in order for the user to review and/or adjust the opening and/or closing parameters (e.g., forces, speeds, acceleration, or the like). The opening and closing parameters may be reviewed by the user on a user interface (e.g., on the user computer system 350, on an output of the door closer 10, another suitable GUI, or the like). In response, the user may adjust the door closer and assist system 100 and/or other components of the door assembly 1 (e.g., hinge alignment, door and frame connection, strike plate and/or locking interaction, or the like) in order to adjust the opening and/or closing of the door 2.

FIG. 29 further illustrates in block 506 that during operation, a door 2 may be manually opened, based on a set operating force of the door closer 10, without the aid of the door assist system 110. For example, the door may be opened manually with a force that is less than or equal to 5 lbs. of force. FIG. 30A illustrates an embodiment in which the door 2 has been opened.

Block 508 further illustrates that after manual opening the door closer 10 begins to automatically close the door 2. For example, the biasing member 20 (e.g., a spring 22 alone or in combination with a damper 30) is activated and the door closer 10 closes the door with a force that is less than required to open the door 2. FIG. 30B illustrates the door closer 10 closing the door.

FIG. 29 further illustrates in block 510 that during closing the door assist system 110 is activated (e.g., a motor 150, or the like) to aid in actuating the door closed based on the operating parameters that were set to aid in the closing of the door 2. That is, to close the door with the same or more force as required to open the door 2. For example, the motor 150 is activated and the drive train 160 is used to apply the torque from the motor 150 (e.g., which may be enhanced by the drive train 160) to the door closer 10 to increase the force at which the door closer 10 closes the door 2. FIGS. 30C and 30D illustrate that the door closer and assist system 100 further closes the door 2, and at the same time the drive assembly 120 is configured to slide with respect to the track 200 as previously described herein.

FIG. 29 illustrates in block 512 how the door assist system 120 may be utilized when the door closer 10 is set such that the door closer 10 will close the door 2 with the desired force without any aid from the door assist 110. As such, instead of the door assist system 110 aiding in closing the door 2, the door assist system 110 will aid in opening the door 2.

Block 514 illustrates that during opening (e.g., when a user moves a door handle, when the presence of the user is detected by a sensor 60, when the door beings to move from a closed position, when the door reaches a specific position, when a particular force is identified, or the like) the door assist system 110 may be activated (e.g., the motor 150, or the like) to actuate the door 2 based on the operating parameters that were set to aid in opening the door 2. For example, when the door closer 10 is set such that it may close with 5 lbs of force or more, the door assist system 110 (e.g., the motor 150) is activated in order to aid in opening the door 2. For example, the door assist system 110 may be activated in order to aid a user in being able to open a door 2 with 5 lbs or less of force.

FIG. 29 further illustrates in block 516 that after opening, and during closing, the door closer 10 closes the door 2 based on the closing force of the door closer (e.g., the pre-set closing force, such as the pre-set spring force, or the like) without the need for the door assist system 110.

It should be understood that the door closer and assist system 100 (e.g., the door closer 10 and/or the door assist 110) may be set to allow for one of either opening or closing to occur without the need for the use of the door assist system 110; however, the door closer and assist system 100 may be set up to operate during both opening and closing to aid in both opening and closing. Moreover, it should be understood that the door assist system 110 may also be utilized to account for situations when the force required to open and/or close the door 2 changes. For example, the door assist system 110 may be utilized when an HVAC system is engaged, when an exterior door is subject to winds during opening or closing, when the door assembly 1 has a mechanical issues (e.g., hinges are binding, hinges need lubricant, the door and frame are misaligned, there is an issue with the strike plate and/or bolt being disengaged, or the like), or other like condition that increases the force required to open and/or close the door 2.

In some embodiments, during opening and/or closing a sensor 60 may provide information to the controller 300 regarding the opening or closing of the door 2 (e.g., angle of the door, speed of the door 2, or the like). For example, one or more sensors 60 may determine the location, speed, and/or acceleration of the door 2 as the door 2 is opening and/or closing. The operation of the door 2 captured from the one or more sensors 60 may be compared with the operating parameters set for the door closer and assist system 110. In response to the comparison of the operation of the door 2 with stored operating parameters, the controller 300 may activate the door assist system 110 to increase the force used to open and/or close the door 2. For example, should the door 2 reach a particular angle (e.g., with respect to the closed position, the open position, or the like), slow to a particular closing speed, slow to a particular deceleration, stop at a particular location, and/or a combination of the forging, the controller 300 may operate the motor 150 to provide additional torque to the door closer 10 for aiding in opening and/or closing. In some embodiments, the controller 300 may increase the torque to the door closer 10 in order to maintain the closing speed and/or deceleration of the door 2, increase the speed and/or acceleration of the door 2, and/or the like.

The present invention described herein solves a number of problems in the industry. That is, the door closer and assist system 100 may be used to meet governmental, customer, or other like entity requirements for the force for opening or closing a door. For example, particular requirements, such as regulations required by the ADA or other regulations of other entities, have become more important for businesses to meet. As such, in particular embodiments the door closer and assist system 100 may meet the current (at the time of filing this application, or as updated over time) requirements for the force for opening and/or closing a door. In particular, at the time of filing this application, door closers 10 may be required by the ADA to allow for manual opening with an opening force of 5lbs. or less (e.g., measured 1 inch from the edge of a 36 inch door, which is 35 inches from a pivot point, or the like). However, other entities may have other requirements for manual door opening (e.g., opening with another force, or less than another force). Door closers 10 may have an adjustable spring that can be adjusted to meet different opening and closing requirements. As noted herein, the closing force of a door 2 that utilizes a door closer 10 is going to be less that an opening force required to manually open the door 2 due to mechanical losses in the door assembly 1. For example, the friction of moving components (e.g., hinges, door and frame interaction, linkages, strike plates, bolts, or the like) reduce the efficiency of door closers 10. Frictional forces may be mitigated using high quality machining and high performing lubrication, but in spite of this, generally, door closers 10 have about 50% efficiency, and potentially less depending on the type of door assembly 1 and the installation of the door assembly 1. As such, the efficiency of the door closer 10 may be 70, 60, 50, 45, 40, 35, 30, 25, or other the like percent (or range between these values, overlap these values, or fall outside of these values). For example, with a typical efficiency of about 50%, a door closer 10 set to open with no more than 5 lbs. of force will have a maximum of 2.5 lbs. of closing force (e.g., assuming there is no drag of misalignment in the door/frame/hinges). This amount of closing force (e.g., 2.5 lbs.) is typically not large enough to close the door completely.

Typical door closers that utilize a spring compress the spring when the door is opened, store energy in the spring, then the spring closes the door when the door is released. Should the door closer have a damper, the fluid (e.g., oil, air) and valves (or other damping components, second springs, or the like) control the speed of the door closing in response to the spring returning to its pre-loaded position at the door's closed position. Door closers typically have adjustable springs (e.g., size 1-6, or other sizes) to meet a variety of door application closing force requirements. Agencies (e.g., Builders Hardware Manufacturers Association—BHMA, other agencies, or the like) define the closing force of the adjustable springs (e.g. sizes 1, 2, 3, 4, 5, 6, or the like) that are used in various industries. For example, a size 1 spring may only have 2 lbs. of closing force, while a size 6 spring may have 14 lbs. or more of closing force. When a requirement is set for opening a door with 5 lbs. of force or less (e.g., as required for ADA compliance), installers typically setup a door closer with a size 1 spring, which typically results in a door opening with no more than 5 lbs. of force, and with a 50% efficient door closer, the door would close with approximately 2.5 lbs. of force. Door closer spring sizes are typically set during initial installation of the door closer 10 and are never adjusted again.

Based on current options, the only way to vary the opening and closing forces of a door is to utilize a door operator instead of a door closer. Door operators can be pushed open manually with a specified force (e.g., to meet ADA requirements, such as no more than 5 lbs. of force at the time of filing this application, or the like requirements of other agencies and/or as updated by the ADA over time) because door operators utilize motors with an automatic open cycle to allow them to meet specified force requirements (e.g., ADA requirements, or the like). For example, a motor in the door operator is used to open the door automatically (e.g., with or without the aid of a user manually opening the door 2). That is, the motor is actually used to move the linkages of the door operator in order to cycle the door open and/or closed. As such, door operators may use powerful springs (e.g., which would typically take much more than 5 lbs. of force to open without the assistance of the motor, such as a size 6 spring, or the like). The more powerful the spring used in door operators more closing power the door operator will have. Also, door operators may utilize the motor to add closing force in addition to the spring closing force. That is, the motor and the spring close the door together (e.g., a cumulative closing force that would be greater than using just the motor or just the spring). The trade-off with respect to using door operators over door closers is that door operators are much more expensive than door closers. As such, should a business be required to meet specific door opening requirements (e.g., to meet ADA requirements, which at the time of filing this application is 5 lbs. or less, or other entity requirements now or required in the future), the business is forced to spend orders of magnitude more on a door operator in order to meet the requirements. Furthermore, door operators, when compared to door closes, require additional related costs such as, the costs associated with the accessories required to use a door operator (e.g., wall plates, electric strike, and signs), as well as the additional installation and setup costs required for the more complex door operators and the accessories. In aggregate, the cost to install a door operator can be 5, 6, 7, 8, 9, 10, 12, 15, or the like times the cost of a door closer.

As described herein, the present disclosure provides an improved system that combines a door closer 10 with a door open assist system 110 that aids in providing additional torque to the door closer 10, when needed, during opening and/or closing in order to allow the door to close while still allowing manual opening of the door to meet preferred force requirements (e.g., ADA opening force, which at the time of filing this application is 5 lbs., or the like force required by any entity now or in the future). Unlike the door operators that require a large motor to physically move linkages and/or compress a spring with a large opening force, the door closer and assist system 100 utilizes a much smaller motor (or other force that provides torque) that is located outside of the door closer 10, and which is not required to move the door itself, but instead aids in applying torque to the door closer 10.

As previously discussed herein, the operating parameters for the door closer and assist system 10 may be set based on operating requirements from different entities. For example, the operating requirements may be set based on statutes, regulations, rules, suggested requirements, or the like set by a governmental entity (e.g., legislative act, agency requirements, or the like). For example, in some embodiments the operating requirements may be set in order to comply with the requirements of the Americans with Disabilities Act (ADA). However, the operating requirements may be set in order to comply with any other regulations set by any government, agency, standards body, consortium of industry members, or the like. Additionally, or alternatively, the operating requirements may be set by the customer purchasing the door, contractor installing the door closer and assist system 100, facility in which the door closer and assist system 100 is being installed, entity that will operate the door closer and assist system 100, or the like, and thus, may have operating requirements that are more stringent than as required by any government, agency, standards body, or the like. It should be understood that the operating parameters may not only include the force requirements for opening and/or closing the door, but also when to activate the door assist system 110 in order to aid in opening and/or closing. It should be understood that before any action is taken with respect to aiding in opening and closing, the door assist system 110 may not be activated for fractions of a second, one, two, three, four, five, or other like seconds, or the like (or ranging between, overlapping, or falling outside of any of these values) in order to make sure that there has been a change in the operating parameters of the door closer and assist system 100 before aiding in the opening and/or closing.

As such, should a door assembly 1 have an opening force that meets the current ADA requirements (e.g., 5 lbs. or less at the time of filing this application, or as updated overtime), the door typically would only have a closing force of about 50% (e.g., approximately 2.5 lbs. or less based on the opening force of 5 lbs. discussed above). The present invention allows for increasing of the closing force, such that the door 2 may maintain a desired opening force (e.g., that meets the ADA requirements, such as 5 lbs. or less at the time of filing this application), and during the closing the closing force is adjusted such that the door 2 closes with a force that is equal to or greater than the opening force (e.g., that meets the ADA requirements, such as 5 lbs. or greater at the time of filing this application). Alternatively, should the door assembly 1 have a closing force that meets the current ADA requirements (e.g., is greater than or equal to 5 lbs., or as modified over time), the force to open the door manually is going to be greater than the force at which the door is going to close due to the loss of efficiency in the door closer 10. As such, the present invention allows for decreasing the opening force, such that the door 2 may maintain an opening force that meets the current ADA requirements (e.g., is 5 lbs. or less, or as modified over time) using the door assist system 100.

While particular embodiments are illustrated that utilize a track 200 and drive assembly 120 operatively coupled to the door closer 10 through a drive arm 172, it should be understood that the drive assembly 120 may be sized and located within the drive arm 172 itself. For example, should the drive arm 172 be large enough the drive assembly 120 may be configured to be located within the drive arm 172 and work in the same or similar way as described herein.

In other embodiments, the drive assembly 120 may utilize timing belts, pullies, and/or other components to transfer the torque from a motor 150 and/or other devices that provide rotational torque that can be transferred to the door closer 10.

Moreover, it should be understood that while the door closer 10 is illustrated as using a spring, the door closer 10 may be any type of door closer 10 (e.g., cam, rack and pinion, hydraulic, pneumatic, or the like).

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and should not be interpreted in an idealized or overly formal sense unless expressly so defined herein. Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the figures. The referenced components may be oriented in an orientation other than that shown in the drawings and the terminology, therefore, should be understood as encompassing such variations unless specified otherwise. It will be understood that when an element is referred to as being “connected,” “coupled,” or “operatively coupled” to another element, the elements can be formed integrally with each other, or may be formed separately and put together. Furthermore, “connected,” “coupled,” or “operatively coupled” to can mean the element is directly connected, coupled, or operatively coupled to the other element, or intervening elements may be present between the elements. Furthermore, “connected,” “coupled,” or “operatively coupled” may mean that the elements are detachable from each other, or that they are permanently coupled together.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A door assist system for a door closer, the system comprising:
a track; and
a drive assembly operatively coupled to the track;
wherein the track is configured to be operatively coupled with a door or with a door frame or a wall;
wherein the drive assembly is configured to be operatively coupled with the door closer through a drive arm, and wherein the door closer is configured to be operatively coupled to the opposite of the door or the door frame or the wall to which the track is operatively coupled; and
wherein the drive assembly is configured to move the drive arm and slide with respect to the track to aid in opening or closing the door.

2. The system of claim 1, wherein the drive assembly comprises:
a carriage;
a motor assembly operatively coupled to the carriage; and
a drive shaft operatively coupled to the motor assembly;
wherein the drive shaft is configured to be operatively couple to the drive arm; and
wherein energy generated by the motor assembly is mechanically transferred to the drive shaft.

3. The system of claim 2, wherein the carriage comprises:
one or more slides configured to contact track surfaces allowing the carriage to slide with respect to the track.

4. The system of claim 3, wherein the carriage comprises:
one or more carriage projections configured to extend into one or more holder cavities formed by one or more track projections, wherein the one or more carriage projections and the one or more holder cavities locate the carriage within the track.

5. The system of claim 4, wherein the one or more carriage projections comprise four carriage projections, and wherein the one or more holder cavities comprise four holder cavities formed by four track projections.

6. The system of claim 2, wherein the carriage comprises:
a first carriage portion; and
a second carriage portion operatively coupled to the first carriage portion to secure the motor assembly and the drive shaft at least partially within the carriage.

7. The system of claim 2, wherein the motor assembly comprises:
a motor; and
a drive train operatively coupled to the motor;
wherein the motor assembly has a reduction ratio of at least 30 to 1 to transfer torque from the motor to the drive shaft.

8. The system of claim 1, wherein the track comprises:
an upper portion;
a face portion; and
a mounting portion.

9. The system of claim 8, wherein the track further comprises:
a lower portion defining a drive shaft aperture;
wherein the drive shaft aperture allows a drive shaft of the drive assembly to slide within the drive shaft aperture when the drive assembly slides with respect to the track.

10. The system of claim 1, wherein the track further comprises:
one or more holder projections extending into a track cavity defined by the track, wherein the one or more holder projections and the track define one or more holder cavities for securing at least a portion of the drive assembly within the track cavity.

11. The system of claim 1, further comprising:
one or more sensors to determine when to activate or deactivate the drive assembly, wherein the one or more sensors comprise a position sensor, a force sensor, or an accelerometer sensor.

12. The system of claim 11, wherein the one or more sensors comprise:
the position sensor is configured to identify a position of the door or the drive assembly for activating or deactivating the drive assembly.

13. The system of claim 1, wherein the door assist system and the door closer are configured to allow opening of the door with less than or equal to five lbs of force and closing of the door with greater than or equal to five lbs of force.

14. The system of claim 1, wherein the drive assembly is activated to aid in closing the door when the door closer has a closing force that is less than or equal to five pounds of force.

15. The system of claim 1, wherein the drive assembly is activated to aid in opening the door when the door closer has a closing force that is greater than or equal to five pounds of force.

16. A door closer and assist system comprising:
a door assist comprising:
a track; and
a drive assembly operatively coupled to the track;
a door closer; and
a drive arm operatively coupling the door assist and the door closer;
wherein the door closer is configured to be operatively coupled with a door or with a door frame or a wall;
wherein the track is configured to be operatively coupled to the opposite of the door or the door frame or the wall to which the door closer is operatively coupled;
wherein the drive assembly is configured to move the drive arm and slide with respect to the track to aid in opening or closing the door.

17. The door closer and assist system of claim 16, wherein the drive assembly comprises:
a carriage;
a motor assembly operatively coupled to the carriage; and
a drive shaft operatively coupled to the motor assembly;
wherein the drive shaft is operatively coupled to the drive arm; and
wherein energy generated by the motor assembly is mechanically transferred to the drive shaft.

18. The door closer and assist system of claim 17, wherein the motor assembly comprises:
a motor; and
a drive train operatively coupled to the motor and the drive shaft;
wherein the motor assembly has a reduction ratio of at least 30 to 1 to transfer torque from the motor to the drive shaft.

19. The door closer and assist system of claim 16, wherein the door closer comprises:
a spring to close the door; and
a damper operatively coupled to the spring to control a closing speed of the door.

20. A method of assisting in opening or closing a door using a door closer and assist system comprising a door assist having a track and a drive assembly operatively coupled to the track, a door closer having a drive arm operatively coupling the door assist and the door closer, wherein the door closer is operatively coupled with a door or with a door frame or a wall, and wherein the track is operatively coupled to the opposite of the door or the door frame or the wall to which the door closer system is operatively coupled, and wherein the drive assembly is configured to move the drive arm and slide with respect to the track to aid in opening or closing the door, the method comprising:
identifying when the door is being moved in an open direction and an opening force to open the door is greater than or equal to a set opening force, and in response activating the drive assembly to assist in opening the door; or
identifying when the door is being moved in a closed direction and a closing force to close the door is less than or equal to a set closing force, and in response activating the drive assembly to assist in closing the door.
